(19) United States
(12) Patent Application Publication
(10) Pub. No.: US 2006/0173558 A1
(43) Pub. Date: Aug. 3, 2006

(54) Digital control method that control error is improved

(75) Inventors: Takehiko Futatsugi, Annaka-shi (JP); Hiroo Sato, Takasaki-shi (JP)

Correspondence Address: Patrick G. Burns, Esq.;Greer, Burns & Crain, Ltd., Suite 2500, 300 S. Wacker Drive, Chicago, IL, 60606, US

(73) Assignees: ADTEX INC.; TAKEHIKO FUTATSUGI

(21) Appl. No.: 11/313,125

(22) Filed: Dec. 19, 2005

Related U.S. Application Data
(63) Continuation-in-part of application No. 10/469,390, filed on Aug. 28, 2003, now abandoned.

(51) Int. Cl. G05B 13/02

(52) U.S. Cl. 700/28

(57) ABSTRACT

The manipulated variable is calculated solving transfer equation (R=q·R+a·C+b·D. Multiplication symbol “·” means convolution R is the controlled variable. C is the manipulated variable. D is the disturbance that is caused by program or is measured. The degree of each q, a, and b is &q, &a, and &b. &a must be greater than peak period of impulse response function.) under the condition that R becomes same as the command value (S) &q periods after, C becomes constant &q periods after, and D can be fed forward till &q+&a−&b periods after. Thus control error becomes very small even when S and D change complicatedly and step wise. (FIG. 8) Parameters (q, a, and b) are tuned using only such differences of R, C, and D, which have sufficient significant digits and only when estimation error is allowable. So that the system can keep stability even if very large not fed forward disturbance happens during automatic tuning.

### CROSS REFERENCE

This is a continuation-in-part of application Ser. No. 10/469,390, filed on Aug. 28, 2003.

### TECHNICAL FIELD

The invention is an improvement of the control method called NACS (New Automatic Control System). In digital control, the controlled variable “R” is measured periodically, and the manipulated variable “C” is calculated so that “R” agrees with the command (settles) “S”. Values of data are treated/calculated as digital numbers. And “C” is output. Such disturbance is called FF disturbance (fed forward disturbance) “D” that is intentionally caused or that is detected by measurement. When it is intentionally caused by program, its future prearranged/scheduled data may be available. While the newest data of “R” is regarded as the value of the last period in conventional art, it is regarded as that of the present period in NACS art. (FIG. 35)
Rₙ=R(nT)=∫_{(n-1)T}^{nT}R(t)dt, Cₙ=C(nT+ε); ε≈0, ε>0 (001)
Rₙ=q₁Rₙ₋₁+q₂Rₙ₋₂+ . . . +q_{&q}R_{n-&q}+a₁Cₙ₋₁+ . . . +a_{&a}C_{n-&a}+b₁Dₙ₋₁+ . . . +b_{&b}D_{n-&b}. (002)

Transfer equation (002) is a recurrence formula. Present state “Rₙ” is the result of internal causes “R_{m<n}” and external causes “C_{m<n}, D_{m<n}”. Neither present nor future can affect present. Therefore, causality rule can be clearly represented and FF disturbance “D” can be easily included in the transfer equation. Equation (002) does not cause simultaneity problem. Coefficients qᵢ, aᵢ, bᵢ (we call them COF (control function)) are got by the regression of (002) such as least square method. (FIG. 34). Total number of parameters (COF) is “&q+&a+&b”. They can also be got by z-transformation of differential equation and the substitution concerning (001).
Rₙ₋₁→Rₙ; aₙ₋₁→aₙ, bₙ₋₁→bₙ; fₙ₋₁→fₙ, gₙ₋₁→gₙ (003)

We use such sequences that the present period can be represented as 0th order. Negative order means past and positive one means future.
R₀=q₁R₋₁+q₂R₋₂+ . . . +q_{&q}R_{-&q}+a₁C₋₁+ . . . +a_{&a}C_{-&a}+b₁D₋₁+ . . . +b_{&b}D_{-&b}. (004)

Differences of “R”, “C”, and “D” are represented by “r”, “c”, and “d”. “R”, “C”, “D”, “r”, “c”, and “d” are generally called “COV (control variables)”.
rₙ=Rₙ−Rₙ₋₁, cₙ=Cₙ−Cₙ₋₁, dₙ=Dₙ−Dₙ₋₁ (005)

The transfer equation using the differences is the same form.
rₙ=q₁rₙ₋₁+q₂rₙ₋₂+ . . . +q_{&q}r_{n-&q}+a₁cₙ₋₁+ . . . +a_{&a}c_{n-&a}+b₁dₙ₋₁+ . . . +b_{&b}d_{n-&b}. (006)

(002) and (006) are generally called “COFRE”. The manipulated variable “c” or “C” is calculated solving COFRE under the condition (FT determining) that “R” agrees with “S” in future. The condition of previous NACS is that “R” agrees with “S” in continuous several future points and as many programmed disturbance-data as possible are used. The invention's condition is that both of “R” and “C” become constant in finite cycles/periods (settling time) and that “D” does not elongate the settling time. The solution is given as the following formulae (MAFRE). (FIGS. 1, 2).

$$\begin{matrix}{c}_{0} = {k}^{′} ( {S}_{\& a} - {R}_{0} ) + {q}_{0}^{′} {r}_{0} + {q}_{1}^{′} {r}_{- 1} + … + {q}_{\& q - 1}^{′} {r}_{1 - \& q} + {a}_{1}^{′} {c}_{- 1} + ⋯ + {a}_{\& a - 1}^{′} {c}_{1 - \& a} + {b}_{\& c - \& qa}^{′} {d}_{\& qa - \& b} + … + {b}_{\& b - 1}^{′} {d}_{1 - \& b} & ( 007 ) \\ {C}_{0} = {K}^{′} {S}_{\& a} + {Q}_{o}^{′} {R}_{0} + {Q}_{0}^{′} {R}_{0} + {Q}_{1}^{′} {R}_{- 1} + … + {Q}_{\& q - 1}^{′} {R}_{1 - \& q} + {A}_{1}^{′} {C}_{- 1} + ⋯ + {A}_{\& a - 1}^{′} {C}_{1 - \& a} + {B}_{\& b - \& qa}^{′} {D}_{\& qa - \& b} + … + {B}_{\& b - 1}^{′} {D}_{1 - \& b} & ( 008 )\end{matrix}$$

While “C, c” and “D, d” is used in MAFRE, control error can be corrected before it appears as “R” or “r”. Namely they are fed forward. The solving condition is a kind of finite time settling. Control is nervous about noise. Filters are usually used to prevent it. But filters make control slow. To substitute filters, error distribution and/or noise compression are used in NACS. During not settled state, it is only compressed by error rate of COF. And during settled state ‘c₀’ is more compressed, so that reaction caused by noise is reduced. Not only these devices causes hardly settling delay, but also it restrains from over-shoot and makes sometime settling time shorter. Therefore this control method gives very fast and accurate control. When the command is complicatedly changed, control-precision/faithfulness is very important. Previous NACS art looks like to give better control-precision/faithfulness. But the invention's art gives better result. (FIGS. 7, 8). Control period can be determined automatically (optimization of period). Except differential equation, number of parameters can be indicated “&q<6, &a<6, &b<6”. If you would like to take “&q=1”, then “&a<10, &b<10”. These arts are generally called degree systemization. If man is satisfied with the speed of PID combined with finite time settling, but requests that period is made widely longer, “&q=1, &a=2, b is omitted” can be selected. This invention offers also art that system is stable even strong not-measurable disturbance happens during tuning. And after the repair or exchange of parts during the interruption of control, system can restore stability. The idea is the following. COF can have sufficient significant digits only using such data that have more than fixed significant digits (tuning diagnosis). Large estimation error (destroyer event) during ordinal control (normal phase) is considered as that large not measurable disturbance happens, and tuning is stopped by the error. But at the beginning of control-restart (fast phase), destroyer event is considered that repair or parts-exchange is made, new COF is calculated and useless old COF is omitted. When response test is necessary, it is done. Thus almost all parameters can be automatically calculated out in test phase and stability is kept even in dangerous case: the system is very intelligence.

The invention is adaptable for various complex systems.

For example:
1. The motor control system that heavy load is charged and discharged.
2. The combined system of speed control and position control.
3. Temperature control in a pipe alternating the control point among the region from the upper stream to the down stream.

### BACKGROUND ARTS

Summary of background art is as the following.

We described above “We use such sequences that the present period can be represented as 0th order. Negative order means past and positive one means future.” These sequences are called LRSF (Left regular sequence field). We define four arithmetic operation of LRSF. Then COFRE is represented as the following.
R=qR+aC+bD (009)
r=qr+ac+bd (010)

These formulae are very simple and easy to see. Four arithmetic operations are carried out like plain number.
a+b=b+a, ab=ba (011)
(a+b)+c=a+(b+c), (ab)c=a(bc) (012)
a(b+c)=ab+ac, (a+b)c=ab+bc (013)
ab=0→a=0 or b=0 (014)

Moreover difference operator “Δ”, sum operator “Σ”, shift operator “Λ” are all elements of LRSF.
Δ₀=1, Δ₁=−1, Δ_{n≠0,1}=0; (Δa)ₙ=aₙ−aₙ₋₁ (015)
Σ_{n<0}=0, Σ_{n≧0}=1; ΔΣ=1; (Σ a)ₙ=a_{&a}+a_{&a+1}+ . . . +aₙ₋₁+aₙ (016)
Λ₁=1, Λ_{n≠1}=0; (Λa)ₙ=aₙ₋₁; a=a_{&a}Λ^{&a}+a_{&a+1}Λ^{&a+1}+ . . . +aₙΛⁿ+aₙ₊₁Λⁿ⁺¹+ (017)

Therefore using (018) or (005), (009) is deformed to (010).
r=ΔR, c=ΔC, d=ΔD; i.e. R=Σr, C=Σc, D=Σd (018)
r=ΔR=Δ(qR+aC+bD)=qΔR+aΔC+bΔD=qr+ac+bd (019)

We explain about causality. Transfer equation of previous art can be written as the following using impulse response function “f”.
rₙ=f₀cₙ+f₁cₙ₋₁+f₂cₙ₋₂+f₃cₙ₋₃+ (020)

This formula represents that present “cₙ” can affect present “rₙ”. Using z-transformation of differential equation, it is deformed to the following formula.
rₙ=q₀rₙ₋₁+q₁rₙ₋₂+ . . . +q_{&q-1}r_{n-&q}+a₀cₙ+ . . . +a_{&a-1}c_{n-&a-1} (021)

While left side has order “n”, “qᵢrₙ₋ⱼ” of the right side has “n−1” and “aᵢcₙ₋ᵢ” of the right side has “n”. It makes arithmetic and theory difficult. Instead of (020) and (021), NACS formulae are (022).
rₙ=f₁cₙ₋₁+f₂cₙ₋₂f₃cₙ₋₃+f₄cₙ₋₄+ . . .
rₙ=q₁rₙ₋₁+q₂rₙ₋₂+ . . . +q_{&q}r_{n-&q}+a₁cₙ+ . . . +a_{&a}C_{n-&a} (022)

It means that present cannot affect present. And order of each term is same.

Concerning z-transformation, NACS can use z-transformation. But after it, orders of some sequences must be shifted by “1”.

We explain about sequence “LRSF”.

Underline of symbols means that symbols are not elements of sequence. The symbol “Σᵢ” means series sum concerning “i” and the symbol “πᵢ” means series product concerning “i”. Underline distinguishes “Σ” from “Σ” that is the sum operator and an element of LRSF. Subscript “i”, which is integer, is a dummy index and various and arbitrary symbols can be used instead of “i”. We use English small letters as dummy indexes for order of series and Greece small letters for not order of series. “μ” and “ν” are especially used for characteristic values. And subscript symbols, which are not order of sequence, are underlined when these are not clear. “iεX” means that “i” is an element of the set “X”. When “X” are sets for dummy indexes, each of “[N]”, “N”, and “[M, N]” means the set of integers of “1˜N”, “0˜N−1” and “M˜N”. For the convenience's sake of description, the set of the dummy index may be defined apart. When the set of a dummy index is not defined, it is the set of whole integers.

Left-regular-sequence-field (LRSF) is very convenient to represent causality in discrete algebra. But LRSF is not popular in control theorem. Therefore LRSF is described at first. Elements of a sequence of number are called terms and their position numbers are called orders. Terms are arranged from left to right so that the left term has the lower order than the right. A sequence is represented by the nth term called general term in { }. When a term of expression or sequence is written in { }, it is its nth term.
a={bₙ₋₂}={cₙ₋₅dₙ₊₂+n⁵}⇄aₙ=bₙ₋₂=cₙ₋₅dₙ₊₂+n⁵ (024)

The popular sequences in control theory begin from the first term and continue to the +∞th term. The set of these sequences is called RIS (right side infinite sequence). We give it the symbol “(1,)”.
{a₁, a₂, a₃, . . . }ε(1,); (025)

The set of sequences, which begins from the −∞th term and continues to the +∞th term, is called BIS (both side infinite sequence). We give it the symbol “(,)”. (FIG. 31)
{ . . . , b₃, b₂, b₁, b₀, b₁, . . . } ε(,); (026)

We consider BIS, and regard not-defined terms as 0. A RIS has lower than 0th order terms that are 0. Thus the set of RIS is a subset of BIS.
{ . . . , 0, 0, 0, 0, b₁, b₂, b₃, . . . }ε(1,); (027)

The subset, each element of which is an element of RIS shifted by finite order, is called LRSF (left regular sequence field). We give it symbol “[,)0”.
{ . . . , 0, 0, 0, a₋₃, a₋₂, a₋₁, . . . }ε[,)0; (028)

Thus we can regard 0th order as present value. It is one of the merits of LRSF that the favorite term can be shifted to the 0th order. Therefore the negative order is called “past”, and the positive order is called “future”. And the 0th order is considered “present” for COV, and time base point for “COF”. It is one of the merits of LRSF that the favorite term can be shifted to the 0th order. Therefore the left side is called also “past”, and the right side is called “future”. And the 0th order is considered “present” for COV and time base point for “COF”.

The sequence, all terms of which are 0, is called zero sequence. It is given the symbol “0”.
0≡{ . . . , 0, 0, 0, 0, 0, 0, 0, . . . } (029)

The rest LRSF except zero sequence is called LRS (left regular sequence). It is given the symbol “[,)”.
a={ . . . , 0, 0, 0, a₋₃≠0, a₋₂, a₋₁, . . . }ε[,) (030)

The sequences, which can be not-LRSF, begin with Greece small letters, special LRSF begin with Greece capital letters or number letters, and normal LRSF begin with English letters.
α, β, γ, . . . ωε(,) A, B, C, . . . , Z, a, b, c, . . . , zε[,)0⊂(,) (031)

In principle, sequences, whose symbols begin with English small letters, are differences of the sequences, whose symbols begin with the corresponding English capital letters. And the sequences, whose symbols begin with Greece small letters, are sums of sequences, whose symbols begin with the corresponding English capital letters.
a=ΔA, b=ΔB, c=ΔC, . . . ; α=ΣA, ⊕=ΣB, γ=ΣC, (032)

Each of LRS has a term that is not zero and that is the lowest. It is called the start term, and its order is called the start order. The start order is represented by “@” followed by an expression of sequences or by the symbol of a sequence.
a={ . . . , 0, 0, 0, a₋₃≠0, a₋₂, a₋₁, . . . }ε[,); @a=−3 (033)

The sequence, which has a finite number of not-zero terms, is called FS (finite sequence). We give the set of FS symbol “[,]”. It is indispensable to finish in finite times of operation for the calculation of control. Therefore it is important to know the characteristics of FS. LRSF except FS is used only for mathematical/logical convenience sake, is not calculated really. FS has a highest not-zero term. It is called the end term, and its order is called the end order. The end order is represented by “&” followed by an expression of sequences or by the symbol of a sequence.
a={ . . . , 0, 0, 0, a₋₃≠0, a₋₂, a₋₁, a₀, a₁, a₂≠0, 0, 0, 0, . . . }@a=−3, &a=2
b·c+d={ . . . , 0, 0, 0, e₋₄≠0, e₋₃, e₋₂, e₋₁, e₋₁, e₀≠0, 0, 0, 0, . . . }@(bc+d)=−4, &e=0 (034)

A set of sequence is also written using the start order and the end order.
aε[m, n]⇄@a=m, &a=n;
aε(m,n]⇄@a≧m, &a=n;
aε[m, n)⇄@a=m, &a≦n;
aε(m, n)⇄@a≧m, &a≦n; (035)
aε[,]⇄∃m, n: finite, @a=m, &a=n;
aε(,)⇄@a≧−∞, &a≦+∞;
aε(,]@a≧−∞, ∃m: finite, &a=m;
aε[,)⇄∃m: finite, @a=m, &a<+∞; (036)

A LRS is represented as the following, too.
A={Aₙ}_{@=k, &=h}={Aₙ}_{[k,h]}; A={Aₙ}_{@=k} (037)

The limit value “limit (n→+∞) Aₙ” is represented by “A_{∞}”.

An FS that is also RIS is called RFS (right finite sequence).

The set of RFS is given symbol “(1,]”. The end order of RFS is called degree, too.
a={ . . . 0, 0, 0, 0, a₁, a₂, a₃, a₄≠0, 0, 0, 0, . . . }ε(1,]@a≧1, &a=4 (038)

Four arithmetic operations are defined as the following.

Addition of BIS is defined by addition of each term.
α+β≡{αₙ+βₙ} (039)

Multiplication is defined by Cauchy-product namely convolution. When it is not clear where symbols of sequences are separated, “·” is used for the symbol of multiplication.
αβ≡{Σᵢαᵢβₙ₋ᵢ}={Σᵢαₙ₋ᵢβᵢ}=α·β; 0α=0 (040)

Since these definitions are symmetry and terms of sequences are numbers, associative law, commutative law, and distributive law are satisfied like number.
(α+β)+γ=α+(β+γ), (α·β)·γ=α·(β·γ)
α+β=β+α, α·β=β·α
α·(β+γ)=α·β+α·γ, (α+β)·γ=α·γ+β·γ (041)

Scalar multiplication is defined by that each term is multiplied by the scalar i.e. number.
Nβ≡{Nβₙ} N: Scalar (041)

The scalar multiple of β and “−1” is represented by “−β” and subtraction is defined by the addition of α and −β.
−β≡(−1)·β (043)
α=β≡α+(−1)·β (044)
α−α=0 (045)

We consider the sum of LRS in the case “A≠−B”. Then all terms of the sum, whose orders are lower than “@A” and “@B”, are “0”. And at least one term that is “Aₙ+Bₙ≠0” exists. Therefore “A+B” belongs to LRS. Including the case of zero sequence, the sum of LRSF belongs to LRSF.
A≠−B→@(A+B)≧MIN(@A, @B) (046)

Similarly, the difference of LRSF belongs to LRSF.
A≠B→@(A−B)≧MIN(@A, @B) (047)

The terms of the product among LRS become as the following. All terms, whose orders are lower than “@A+@B”, are the sum of the product where either “Aᵢ” or “Bₙ₋ᵢ” is 0.

Thus these terms are all 0. We can neglect the product of 0. The (@A+@B)th term is the product of “A_{@A}” and “B_{@B}” and it is not 0. All terms of higher order than “@A+@B” are sums, each of which begins from the product of “A_{@A}” and ends with the product of “B_{@B}”.
AB={A_{@A}B_{n-@A}+A_{@A+1}B_{n-@A-1}+ . . . +A_{n-@B}B_{@B}}_{@=@A+@B} (048)
A≠0, B≠0→@AB=@A+@B (049)

Therefore the start order is “@A+@B”. Considering the start term, it is clear that no zero-divisors exist in LRSF. This law is called reduction law.
AB=0→A=0 or B=0 (050)

Man must pay attention to that zero-devisors exist in BIS. For example;
{p₀ⁿ}·(1−p₀Λ)={p₀ⁿ·1+p₀ⁿ⁻¹·(−p₀)}=0; {p₀ⁿ}∈[,)0 (051)

Let's consider COFRE when causes doesn't exist “a C+bD=0”.
R=qR+aC+bD, 1−q≠0; ∴(1−q)R=aC+bD (009)

While the result “R≠0” cannot exist in the range of LRSF, it can exist in BIS. In order that causality is clearly described, it is necessary to sequences to LRSF.

“Any result has its cause.”

Using LRSF, initial condition is given as initial cause. When control starts, initial data are sampled, then initial state is set and initial cause is automatically and naturally estimated.

It is called regular that division is possible. Division is defined by solving the product among LRS from the start term. The result is given as recurrence formula.
C=A/B≡{C_{n<@C}=0, C_{@C}=A_{@A}/B_{@B},
C_{n>@C}=(A_{n+@B}−C_{@a}B_{n-@C}−C_{@a+1}B_{n-@C-1}− . . . −Cₙ₋₁B_{@B+1})/B_{@B}} (052)
A≠0, B≠0→@(A/B)=A−@B (053)

Addition, subtraction, and multiplication can be freely operated in integers. But division is strongly limited. For example, “1” can not be divided by “3”. The circumstances are the same in RIS. Division except zero division can be freely operated in rational numbers extended from integers. So can be done in LRSF extended from RIS. The set is called field of quotients, in which division except by zero can be operated and which is expanded from the set where division is impossible or strongly limited. LRSF is the field of quotients of RIS. But division cannot be freely operated again in BIS extended from LRSF. The four rules in arithmetic of LRSF are the same as that of rational number. The rules of vectors or matrixes are different from rational number so that commutative and reduction laws are not satisfied. But man must pay attention to that limits-operation is not closed in LRSF similar to rational number. Therefore man must confirm whether the resulted sequence belongs to LRSF.

The sum, difference and product among FS are also FS. But the quotient of FS is generally not FS. The rule of the end order is similar to the rule of the start order as the following.
a≠−b; a, bε[,]→&(a+b)≧MAX(&a, &b) (054)
a≠b; a, bε[,]→&(a−b)≦MAX(&a, &b) (055)
a, b≠0; a, bε[,]→&(a·b)=&a+&b, (ab)_{&ab}=a_{&a}b_{&b} (056)
a, b≠0; a, b, a/bε[,]→&(a/b)=&a−&b, (a/b)_{&a/b}=a_{&a}/b_{&b} (057)

The following sequences are called scalar sequences and their notation “N” are scalar and represented by number letters. For example, “1” means the unit sequence {1}_{[0,0]}, and “0” means zero sequence “{0}”. The product of “N” and an arbitrary sequence “α” is the same as scalar multiple. Since it is not a problem even if sequence “N” is mixed with scalar “N”, both are regarded as the same.
N≡{N}_{0,0]}={N₀=N, N_{≠0}=0} (058)
1≡{1₀=1, 1_{n≠0}=0} (059)
0≡{0} (060)
(061)1·α=α·1=α, A/1=A (061)
Aε[,)→A/A=1 (062)
α−α=0, α+0=α−0=α, 0·α≡0 (063)

Positive power method of BIS is defined by the following.
α¹≡α, αⁿ⁺¹≡α·αⁿ; nε[1, +∞) (064)

And zero and negative power method of LRS is defined by the following.
Aε[,)→Aⁿ⁻¹≡Aⁿ/A, A⁰=1; nε(−∞, +∞) (065)

Operators for z-transformation, difference and sum are all represented by special LRS.
Λ≡{Λ₁=1}_{[1,1]} (066)
Λ^{m}={Λ^{m}ₘ=1}_{[m,m]} (067)
Z≡Λ⁻¹={Z₋₁=1}, Z^{m}={Z^{m}₋ₘ=1}_{[-m,-m]} (068)

Arbitrary sequence “α” is represented by its term using single term operator “Λ”.
α=ΣₙαₙΛⁿ (069)

The sequence, whose order is lower than “α” by m, is written “Λ^{m}α” or “Z^{-m} α”, and the sequence, whose order is higher than “α” by m, is written “Λ^{-m}α” or “Z^{m}α”. We call “Λ^{m}” past operators and “Z^{m}” future operators. The 0th terms of “Λ^{m}α” and “Z^{m}α” are “α₋ₘ” and “αₘ”. Both “Λ^{m}” and “Z^{m}” are called shift operators, too.

Special sequences have plural names corresponding to the functions.
Λ^{m}α={αₙ₋ₘ}, (Λ^{m}α)₀=α₋ₘ; Z^{m}α={αₙ₊ₘ}, (Z^{m}α)₀=αₘ (070)

The definition of division can be represented using “Λ”.
C=A/BC={A−(B−B_{@B}Λ^{@B})C}/(B_{@B}Λ^{@B}) (071)

In the special case “B=1−D, Dε(1,)”, the division becomes the following.
Dε(1,) [symbol] C=A/(1−D) [symbol] C=A+DC⇄A=C−DC (072)

The product of “Λ” and an arbitrary sequence “α” is the difference of “α”.
Δ≡1−Λ={1, −1}_{[0,1]}, α={αₙ−αₙ₋₁} (073)

(Caution! Difference is defined “αₙ₊₁−αₙ” in many previous arts.)
Σ≡Δ⁻¹={1}_{@=0}={ . . . , 0, 0, Σ₀=1, 1, 1, . . . }=Z/(Z−1)=1/(1−Λ) (074)

The following sequence has the same terms that are higher than the start term. It is called a constant sequence.
A={ . . . , 0, 0, 0, Aₘ, Aₘ, Aₘ, . . . }; m=@A (075)

Since “Σ” is the constant sequence, whose start order is 0, arbitrary constant sequence is represented by the product of its start term, shift operator, and Σ.
A={A_{n≧@A}=A_{@A}}=A_{@A}Λ^{@A}Σ (076)
Δ·A={ . . . , 0, 0, 0, Aₘ, 0, 0, . . . } (077)

The product of the sum operator “Σ” and an arbitrary sequence “α” is the sum of “α”.

And the partial sums are represented by (079).
Σα={Σ_{i=-∞}ⁿαᵢ} (078)
(Zⁱ−Z^{j})Σa={Σₖ₌ⱼ₊₁ⁱaₙ₊ₖ}={Aₙ₊ᵢ−Aₙ₊ⱼ}, A=Σa (079)

Any FS “a” makes the sum “A”, whose higher than “&a” terms are constant “A&a”.
aΣ[,], A=Σa→A_{n≧&a}=A_{&a}=a_{@a}+a_{@a+1}+ . . . +a_{&a} (080)

If the terms of “A”, whose orders are higher than or equal to M, are constant, “A” is the sum of an FS, whose end order is M.
A_{n≧M}=A_{M}→∃aε[,], &a=M, A=Σa (081)

If LRS “B” is the product between FS “a” and LRS “C”, and “C_{n≦M}” are constant, then “B_{n≦M+&a}” are constant, and the “ΔB” is a FS.
B=aC, C_{n≧M}=C_{M}, aε[,]→B_{n≧M+&a}=A_{&a}C_{M}, A=Σa⇄
⇄&b=M+&a, b=ΔB∵B=aC=aΣc=Σ(ac), b=ac (082)

In control theory, such sequences are also important that converge on zero. Characteristic functions of Laplace transformation are described as the following.
(M−1)!·L⁻¹((s−a)^{-M})=t^{M-1}·exp(at), 0≦t; (083)

L⁻¹: reverse Laplace transformation, !: factorial

In the case that real part of “a” is negative, functions (083) converge on zero as “t” becomes “+∞”. Function (083) are written in sequence form (084).
{n^{M}pⁿ}_{[1,)}=s_{M}(pΛ)/(1−pΛ)^{M+1}; M=0, 1, 2, 3, (084)
s_{N}(x)≡(1−x)^{N+1}(xd/dx)^{N}(x/(1−x));
s₀(x)=x, s₁(x)=x, s₂(x)=x(1−x), s₃(x)=x(1+4x+x²), . . .
s₀(pΛ)ε[1,1], s_{N>0}(pΛ)ε[1, N]→s_{N(}pΛ)ε[1, N+1) (085)

Namely, “{n^{M}pⁿ}_{[1,)}” becomes RFS [1, M+1) if it is multiplied by “(1−pΛ)^{M}”.

We explain z-transformation including term-shift for NACS.

Z-transformation is a technique to transform from analogue system (A-system) to digital system (D-system). The symbols of A-system are distinguished by super script of “A”. Except non-linear control system and distributed constant system, the system (causality rule between “C” and “R”) is represented by a linear differential equation. And sometime it is added dead time (A-eq.).
(s^{N}+q^{A}₁s^{N-1}+q^{A}₂s^{N-2}+ . . . +q^{A}_{N})R(t)=(a^{A}₁s^{N′}+a^{A}₂s^{N′}++a^{A}_{N})C(t); N′<N
p^{A}(s)≡s^{N}+Σₙ₌₁^{N}q^{A}ₙs^{N-n}; a^{A}(s)≡Σₙ₌₁^{N′}a^{A}ₙs^{N-n}
p^{A}(s)R(t)=a^{A}(s)C(t); s=d/dt (086)

The condition “N′<N” is called integral condition that is said causality representation.

The following initial condition is supposed. The condition means that the system is stationary and represented zero before the start of control. If A-eq. is Laplace transformed under the condition, Laplace transformation operator “s” is simply substituted for “d/dt”.
dⁿR(t≦0)/dtⁿ=dⁿC(t≦0)/dtⁿ=0; nεN+1 (087)

Transfer equation is divided by “p^{A}(s)”.
R(s)=(a^{A}(s)/p^{A}(s))C(s)=f(s)C(s); f(s)≡a^{A}(s)/p^{A}(s)
p^{A}(s)≡π_{μ=1}^{M}(s−p^{A}_{μ})^{Kμ}; Σ_{μ=1}^{M}K_{μ=N}
a^{A}(s)≡a^{A}_{N}π_{μ=1}^{N′}(s−a^{A}_{μ}) (088)

Numerator “p^{A}(S)” is factorized to N factors “s−p^{A}_{μ}”, and denominator “a^{A}(s)” is factorized to N′ factors “s−a^{A}_{μ}”. N′ is less than N. Numerator has M different value poles “p^{A}_{ν}”. And it has “K_{ν}” poles if “p^{A}_{ν}”. “K_{ν}” is called duplication value. Denominator has N′ poles “a^{A}_{μ}”. If a “p^{A}_{μ}” is equal to any “a^{A}_{μ}” then “p^{A}_{μ}” is called common pole and “s−p^{A}_{μ}” is called a common factor. Such equation is called irreducible that has no common factors. When common pole “p^{A}_{μ}” exists, such changing cannot be measured that is represented by the common pole. Both sides of transfer equation must be divided by all common factors and be made irreducible. The ratio “f(s)” is called propagator. Propagator is expanded into partial fractions.
f(s)=Σ_{μ=1}^{M}Σₘ₌₁^{Kμ}f′_{μ,m}(s−p^{A}_{μ})^{-m} (089)

Then, “R(s)” is reverse Laplace transposed. Multiplication is changed into convolution.
R(t)=L⁻¹(R(s))=∫₀^{t}f(x)1(x)C(t−x)dx; L⁻¹: reverse Laplace transformation (090)
f(t)=L⁻¹(f(s))=Σ_{μ=1}^{M}Σₖ₌₁^{Kμ}(f′_{μ,k}·T^{k-1}/(k−1)!)·(r/T)^{k-1}·p_{μ}^{t/T}; p_{μ}≡exp(p^{A}_{μ}T) (091)
1(x<0)≡0; 1(x>0)≡1 (092)

“1 (t)” is unit step function. Considering the case that C(t) changes unit pulse δ(t) at t=0, f(t) is found the impulse response function (IREF).
R(t)=∫₀^{t}f(x)1(x)δ(t−x)dx=f(t) (093)

We use the condition of digital control: “R” is measured periodically and the command “S” is given at the beginning of each control cycle “n T”. “C” is calculated out using “R” and “S” and is output delayed by the negligible management/calculation time “ε”. “ε” is usually neglected. “C” is maintained constant till the output in the next period.
Rₙ=R(nT), Cₙ=C(nT+ε); ε≈0, ε>0 (094)

Caution! Rₙ₋₁=R(nT−ε), Cₙ=C(nT) in many previous arts.
Rₙ=∫₀^{nT}f(t)C(nT−t)dt=Σₘ₌₁ⁿCₙ₋ₘ∫_{(m-1)T}^{mT}f(t)dt=Σₘ₌₁ⁿfₘCₙ₋ₘ (094)
fₙ≡∫_{(n-1)T}^{nT}f(x)dx=Σ_{μ=1}^{M}Σₖ₌₀^{Kμ-1}(f′_{μ,k}T^{k}/(k−1)!)∫ₙ₋₁₎ⁿt^{k}p_{μ}^{t}dt
∫_{+∞}^{x}t^{k-}·e^{at}dt=a⁻¹e^{at}Σⱼ₌₀^{k}(−1)^{j}n!a^{-j}x^{k-j}/(k−j)!≡e^{at}Σⱼ₌₀^{k}p_{k,j,μ}x^{k-j} (095)

$${f}_{n} = {{\underline{\sum }}_{μ = 1}}^{M} {{\underline{\sum }}_{k = 0}}^{{K}_{μ - 1}} {\underline{\sum }}_{j = 0}^{k} ( {f}_{μ , k} {p}_{k , j , μ} {T}^{k} / ( k - 1 ) ! ) \\ ( {n}^{k - j} - {{p}_{μ}^{n - 1} ( n - 1 )}^{k - j} ) {p}_{μ}^{n} \\ ≡ {\underline{\sum }}_{μ = 1}^{M} {\underline{\sum }}_{k = 1}^{{K}_{μ}} {\underline{\sum }}_{j = 0}^{k} {f}_{μ , k , j} {n}^{k - j} {p}_{μ}^{n} \\ ≡ {\underline{\sum }}_{μ = 1}^{M} {\underline{\sum }}_{k = 0}^{{K}_{μ - 1}} {f}_{μ , k} {n}^{k} {p}_{μ}^{n} \qquad ( 096 )$$

{n^{M}pⁿ}_{[}1,)=s_{M−1}(pΛ)/(1−pΛ)^{M} (084)
f={fₙ}Σ_{μ=1}^{M}Σ_{K=0}^{Kμ-1}f_{μ,k}sₖ₍p_{μ}Λ)/(1−p_{μ}Λ)^{k+1}=Σ_{μ=1}^{M}Σₖ₌₀^{Kμ-1}f_{μ,k}{n^{k}p_{μ}ⁿ}_{[1,)} (097)
1−q≡π_{μ=1}^{M}(1−pμΛ)^{Kμ}; q₀=0; qε(1, N] (098)
a≡(1−q)f=Σ_{μ=1}^{M}Σₖ₌₀^{kμ-1}f_{μ,k}sₖ(p_{μ}Λ)(1−p_{μ}Λ)^{Kμ-k-1}π_{ν≠}μ(1−p_{ν}Λ)^{Kν}ε(1, N]
∵sₖ(p_{μ}Λ)(1−p_{μ}Λ)^{Kν-k-1}π_{ν≠}μ(1−p_{ν}Λ)^{Kν}ε(1N]∵s₀(p_{μ}Λ)ε[1,1] (099)
∴(1−q)R=aC (100)
R=qR+aC; qε(1, N], aε(1, N] (101)
r=ΔR=ΔqR+ΔaC=qr+ac; (102)

Formulae (101) and (102) are COFRE. And they are called C-eq., too. And (100) is conversion formula. We call (101) also C-eq., which is derived from differential equation.

As mentioned above, causality is well represented using LRSF and COFRE. We expatiate on COFRE. We let the causes be “C” and “D”, and we let the result be “R”. The most universal linear expression is described as the following using RIS f and g.

“Only past can effect present and neither present nor future can effect present.”
R=fC+gD; f, gε(1,) (103)
Rₙ=f₁Cₙ₋₁+f₂Cₙ₋₂+f₂Cₙ₋₂+ . . . +g₁Dₙ₋₁+g₂Dₙ₋₂+g₃Dₙ₋₃+ (103)

This expression is called REFRE (REF-representation) and “f” and “g” are called IREF (Impulse response function). It is the representation of causality that IREF is RIS. The sums of IREF namely “F” and “G” are called SREF (Step response function). IREF and SREF are called REF (response function) generally.
F=Σf, G=Σg (104)

Considering “R” itself can be the cause for “R”, the following expression is obtained.
R=qR+aC+bD; q, a, bε(1,) (105)

The coefficients “q”, “a” and “b” are called COF (control function). REF and COF are called CAF (causality function). And this expression is called COFRE (COF-representation). We usually make the manipulated variable “C” and FF disturbance “D”. Then we call “q” controlled function, “a” manipulated function, and “b” FF function (feed forward function). Relation between COF and REF is called conversion formula.
a=(1−q)f, b=(1−q) i.e. f=a/(1−q), g=b/(1−q) (106)

COFRE is explained as the following. Let's consider a bell. While the interval that the tongue touches the bell is short, the bell sounds for a while (reverberation time). The effect is represented by “a” or “b” while the tongue touches the bell. Namely “a” and “b” are considered signal transferring rates. And the left sound is represented by “q” after the tongue gets separated. Therefore “q” is considered damping rate and/or rotating rate of vibration phase. Since these effects are simple, “a”, “b” and “q” can usually be represented by RFS.
R=qR+aC+bD, q, a, bε(1,] (009)

It is to represent causality concisely that COF is RFS. The start order of CAF must be greater than or equal to one. The start order of CAF is simply expressed “one” considering “Zero is only the special case”.

Thus causality is generally represented by REFRE or COFRE and CAF.

The set of REFRE, COFRE and conversion formula is called NACS-set.

Since “Δ” and “Σ” are LRS, NACS-set can be deformed to various expression multiplied both sides by “Δ” or “Σ”.
r=fc+gd=qr+ac+bd, R=Fc+Gd=Qr+Ac+Bd,
ρ=FC+GD=fγ+gδ, R=Fc+gD=qR+Ac+bD, . . .
r=ΔR, c=ΔC, d=ΔD; F=Σf, G=Σg, Q=Σq,
A=Σa, B=Σb; ρ=ΣR, γ=ΣC, δ=ΣD, (108)

Conversion formula can be represented solving about “f” or “g”.
f=a/(1−q)=a+qf, g=b/(1−q)=b+qg (109)

The following description is to explain finite time settling.

Asymptotic settling is the method to make “R” asymptote or approach to “S” in infinite time like PID control. And finite time settling makes “R” to agree with “S” in a finite time. FT settling is used in NACS. But finite time settling of NACS means a little different from that of other art. Therefore we use term “FT settling” for NACS.

The simplest finite settling is realized using MTC (Minimal-Time Control). An electric circuit is drawn in FIG. 4. A register (1) and a capacitor/condenser (2) are connected with a voltage source (3). The voltage of the source is the manipulated variable (C), and the voltage of the capacitor is the controlled variable (R). All “R”, “C” and the command (S) are 0 volt initially. When “S” is changed from 0 volts to “S₁” volt, “C” is changed to the Maximum voltage (C^{MAX}) by the switcher (4) (curve 5 of FIG. 5). While “R” is observed, just time when “R” becomes “S₁”, “C” is changed to “S₁”. Then “R” is maintained “S₁” hereafter (curve 7 of FIG. 5). This method realizes a perfect settling in the minimal time.

In a digital control, “R” is measured periodically, and then “C” is calculated out using “R”. The measurement can hardly coincide with the time of matching of “R” with “S₁”, even if the calculation time is negligible. The following art makes finite time settling possible. “C” is set “C^{CAL}”, which is calculated to make “R” agree “S₁” at the next sampling time, instead of “C^{MAX}” (curve 6 of FIG. 5). But if “C^{CAL}” exceeds “C^{MAX}” then “C^{CAL}” is limited to “C^{MAX}” and the calculation is tried in the next period. Thus finite time settling can be realized also in digital control (curve 8 of FIG. 5). The representation system is the following. Here, “f(s)” is propagator and “f(t)” is impulse response function (IREF) (curve 9 of FIG. 6).
f(s)=K/(s+s₀); s: Laplace transformation operator
f(t>0)=K·exp(−s₀t); f(t): IREF (110)

J. G. Ziegler and N. B. Nichols has proposed famous setting method for PID control. This method has been proved to be applicable to various PID controls. It has a form that this exponential function is combined with a dead time. Formula (111) is the transfer equation used in the method. We call it Ziegler-Nichols model (curve 10 of FIG. 6).
f(s)=K·exp(−T_{L}s)/(s+s₀); T_{L}: dead time
f(t≦T_{L})=0; f(t>T_{L)=}K·exp(−s₀(t−T_{L})), 0<s₀≈0 (111)

More improved finite time settling for digital control has been proposed. It is referred in the following as “MRAS”.
(R02) Yasuto Takahashi, “Shisutemu to seigyo I, II” (Systems and controls 1,2) Iwanami Shoten 1978 (mainly referred in II)

It is said the energy theorem is satisfied that “R” becomes constant in a time when “C” is maintained constant. As far as the energy theorem is satisfied IREF asymptotes to zero finally in the system. Its IREF has an arbitrary form before the diminution and it decreases in an exponential function. This IREF is an extension of Ziegler-Nichols model. (FIG. 3).
rₙ=f₀cₙ+f₁cₙ₋₁+f₂cₙ−2+ (112)
rₙ≡Rₙ−Rₙ₋₁, cₙ≡Cₙ−Cₙ₋₁ (113)

“rₙ” is the difference of the controlled variable “Rₙ” in the nth period and “cₙ” is the difference of the manipulated variable “Cₙ”.

The exponential diminution part of IREF “f_{n≦N}” is represented by a damping factor “q”.

Here “M” means the beginning of the decrement.
f_{n>M}=qfₙ₋₁ (114)

$${r}_{n} - q {r}_{n - 1} = {f}_{0} {c}_{n} + ( {f}_{1} - q {f}_{0} ) {c}_{n - 1} + … + ( {f}_{M} - q {f}_{M - 1} ) {c}_{n - M} + ( {f}_{M + 1} - {q}_{1} {f}_{M} ) {c}_{n - M - 1} + … \\ = {a}_{1} {c}_{n - 1} + {a}_{2} {c}_{n - 2} + {a}_{3} {c}_{n - 3} + … + {a}_{M} {c}_{n - M} \qquad ( 115 )$$

a₀≡f₀, a_{n≧1}≡fₙ−qfₙ₋₁, a_{n>M}=0 (116)
rₙ=qrₙ₋₁+a₀cₙ+a₁cₙ₋₁+a₂cₙ₋₂+ . . . +a_{M}c_{n-M} (117)

COF is easily identified using regression methods such as least squares estimation or successive identification, which are well known. We suppose the present time is the Nth period and the command “S” is constant from the next period (s_{n>M+1}=0). Then, if “R” is settled in the (N+M)th period and the (N+M+1)th period, “R” is settled forever thereafter as is concluded inductively.

$$\begin{matrix}{r}_{n > M + 1} = q {r}_{n - 1} + {a}_{0} {c}_{n} + {a}_{1} {c}_{n - 1} + {a}_{2} {c}_{n - 2} + … + {a}_{M} {c}_{n - M} \\ = q {r}_{n - 1} \\ = q ( q {r}_{n - 2} + {a}_{0} {c}_{n - 1} + … + {a}_{M} {c}_{n - M - 1} ) \\ = … \\ = q {r}_{M + 1} \\ = 0\end{matrix} \qquad ( 118 )$$

This means that “R” is settled in “M” periods if “C_{N}” and “C_{n>N}=C_{N+1} i.e. c_{n>N+1}=0” are so set that “R” is settled in the (N+M)th and the (N+M+1)th period.

Namely, there is only a problem how “C_{N}” and “C_{N+1} “are calculated. A calculation method was proposed using a state vector (vₙ), which is renewed after the output of command “C_{N}” in each period.
v_{n≠&a}=aₙc_{N}+vₙ₊₁, v_{N}=a_{N}c_{N}+qv_{N} (119)

This method is described in (R02). This method is not so hard to calculate “C”, but it is very difficult to understand and to explain. It is written in the reference that vectors and parameters are used for the technical sake and they have no physical meaning. The system is usually perfectly settled in “M” periods, as is the theory. The reference warns to avoid automatic tuning. When parameters, which are calculated from the data of the successfully carried out control, is used the system sometimes becomes unstable. The system cannot be controlled. It is also a problem that there is no standard how much “M” is. “M” becomes more than twenty or more than forty in some cases. Therefore, this method was gradually neglected. One of the applicants of this application, Mr. FUTATSUGI Takehiko tried to avoid these problems. He has used LRSF and succeeded in giving FT settling a background theory or new control system, and has found successfully the cause of instability and the method to avoid the instability. Auto tuning is possible. He had proposed Adtex inc. to bring this technology into practice. We have applied following patents before this application.
(R01) JPA/H10-87887, PCT/JP99/00837, PCT/JP98/02017, PCT/JP99/02369, PCT/JP98/00959, PCT/JP98/02968, PCT/JP99/03519, PCT/JP98/01224

We call this new art NACS (New Automatic Control System) and the previous art OACS (Old Automatic Control System). It is clear that the vector is one of causes that make control unstable. When parameters are identified/renewed, old values and new values are mixed. He had to find other calculation method, too. But the problem was not only these.

Calculation method of C for previous NACS is described at first.
rₙ=q₁rₙ₋₁+ . . . +q_{&q}r_{n-&q}+a₁cₙ₋₁+ . . . +a_{&a}c_{n-&a}+b₁dₙ₋₁+ . . . +b_{&b}d_{n-&b} (120)
rₙ=f₁cₙ₋₁+f₂cₙ₋₂+f₃cₙ₋₃+ . . . +g₁dₙ₋₁+g₂dₙ₋₂+g₃dₙ₋₃+ (121)
a_{n<1}=a_{n>&a}=0, f_{n<1}=0, b_{n<1}=b_{n>&a}=0, g_{n<1}=0,
fₙ=aₙ+q₁fₙ₋₁+ . . . +q_{&q}f_{n-&q}, gₙ=bₙ+q₁gₙ₋₁+ . . . +q_{&q}g_{n-&q} (122)

The manipulated variable is calculated out as the following. We classify “c” into “c^{P}” and “c^{F}”. Here, “c^{P}” is the value when “C” is supposed to be kept the value of the last period and “c^{F}” is the correction for settling.
c=c^{P}+c^{F}, c^{P}_{n≧0}=0, c^{F}_{n<0}=0 (123)
r=qr+a(c^{P}+c^{F})+bd (124)

We estimate the future value “r^{P}” till the (&q+&a)th period supposed “c^{F}=0”.
r^{P}=qr^{P}+ac^{P}+bd, r^{P}_{n≦0}≡rₙ (125)

Each “r” and “r^{P}” is represented by REFRE.
r=f(c^{P}+c^{F})+gd, (126)
r^{P}=fc^{P}+gd (127)

We get the following expression taking the difference of (126) and (127).
r−r^{P}=fc^{F} (128)

Because it is natural “R” changes when either “S” or “D” changes, we request FT settling only when “r” is FT settled only when “(bd)_{n>&a}=0 and s_{n>&a}=0”.

Let's consider settling in the case that (129) is satisfied.
d_{n>&a-&b}=0, s_{n>&a}=0, c^{F}_{n>&q}=0 (129)

Then we get the following result from (124).
r_{n>&q+&a}=(qr)ₙ, s≡ΔS (130)

Since “q” is RFS of degree “&q”, “r_{mε[n-&q,n-1]}=0” makes “rₙ” zero.
r_{n-&q}=r_{n-&q+1}= . . . =rₙ₋₁=0→rₙ=0 (129)

FT settling is realized.

Therefore we request the following condition considering “s_{n>&a}=0”.
r_{nε[&a+1,&a+&q]}=sₙ (130)

Then “r_{n>&a}” becomes zero by induction when “s_{n>&a}=0”.

Thus FT settling is achieved if “R_{&a}=S_{&a}”

$$\begin{matrix}{S}_{n \geq \& a} = {R}_{n} \\ = {R}_{0} + {r}_{1} + {r}_{2} + … + {r}_{n} \\ = {R}_{0} + {r}_{1}^{P} + {r}_{2}^{P} + … + {r}_{n}^{P} + {( f {c}^{F} )}_{1} + {( f {c}^{F} )}_{2} + … + {( f {c}^{F} )}_{n}\end{matrix} \qquad ( 131 )$$

Eₙ≡Sₙ−R₀r^{P}₁−r^{P}₂− . . . −r^{P}ₙ
Fₙ≡f₁+f₂+ . . . +fₙ

Thus the simultaneous linear equation to be solved (132)(133) is obtained.
Fₙc^{F}₀+Fₙ₋₁c^{F}₁+ . . . +F_{n-&q}c^{F}_{&q}=Eₙ, nε[&a, &qa], &qa=&q+&a

Formula (134) is solved using the following matrix.
F_{i,j}≡F_{&a+i-j}; c=(c^{F}₀, . . . , c^{F}_{&q})^{T}; E=(E_{&a}, E_{&a+1}, . . . , E_{&qa})^{T};^{T}: transpose (135)
c=F⁻¹E (136)

(136) is calculated, and “C₀=C₋₁+c^{F}₀” is output.
C₀=C₋₁+c^{F}₀ (137)

We request the condition of FT settling only when both of the command and the disturbance are constant. We ignore the condition. Even when “d_{n>&a-&b}≠0, s_{n>&a}≠0”, “E” and “r^{P}” are calculated by (127) and (132).
r^{P}=fc^{P}+gd (127)
Eₙ≡Sₙ−R₀−r^{P}₁−r^{P}₂− . . . −r^{P}ₙ (132)

The following description is concerning simulation of NACS. Many problems have been solved by simulation. Simulation of NACS can be performed outputting to the model system instead of the control element. In the model system, the manipulated variable can be calculated by COFRE.
R_{Sim}=q_{Sim}R_{Sim}+a_{Sim}C_{Out}+b_{Sim}D_{Sim}
c=F⁻¹E, C_{Out}=C₋₁+c^{F}₀ (139)

R_{Sim}, q_{Sim}, R_{Sim}, a_{Sim}, b_{Sim} and D_{Sim} are values of the model system and C_{Out}, is the value calculated using the real determination system and output to the model control element. If noise made by random function is added to model values such as the manipulated variable or FF disturbance, the effect of noise is evaluated. The command can also be varied stepwise or as polynomial curve made by random function.

Instead of (O30), man can use values calculated using differential equation.

COF is identified by regression when necessary data X, Y are completed.
&qab≡&q+&a+&b
X_{nε[&qab]}≡(rₙ₋₁, . . . , r_{n-&q}; cₙ₋₁, . . . , c_{n-&a}; dₙ₋₁, . . . , d_{n-&b})^{T}
X≡(x₁, x₂, . . . , x_{&qab})^{T}, Y≡(r₁, r₂, . . . , r_{&qab})^{T}
COF≡(q₁, . . . , q_{&q}, a₁, . . . , a_{&a}, b₁, . . . , b_{&b})^{T}
Y=X·COF→COF=X⁻¹Y (140)

Here, “X” is a matrix, and “Y” and “COF” are vectors. And when more data are sampled, COF is usually calculated by least square method.
xₙ≡(rₙ₋₁, . . . , r_{n-&q}; cₙ₋₁, . . . , c_{n-&a}; dₙ₋₁, d_{n-&b})^{T}
X≡(x₁, x₂^{T}, . . . , x_{N}^{T})^{T}, Y≡(r₁, r₂, . . . , r_{N})^{T}
COF≡(q₁, . . . , q_{&q}, a₁, . . . , a_{&a}, b₁, . . . , b_{&b})^{T}
COF≡(X^{T}X)⁻¹(X^{T}Y) (141)

But prototype (141) is inconvenient when the COF changes or new data x, y are added in succession. “M_{X}”, “Y_{X}” and “S_{Y}” are used instead of “X^{T}X”, “X^{T}Y” and “Y^{T}Y”.
Mₓ=X^{T}X, Y_{X}=X^{T}Y, S_{Y}=Y^{T}Y (142)

We let the (N^{ID})th data be “x” and “y”. “p^{ID}” is called renovation rate.
N^{ID}=N^{ID}+1, if N^{MAX}<N^{ID}” then N^{ID}=N^{MAX}
p^{ID}≡1/N^{ID}, x=(r₋₁, . . . , r_{-&q}, c₋₁, . . . , c_{-&a}, d₋₁, . . . , d_{-&b}); y=r₀ (143)

New data are added to “M_{X}”, “Y_{X}” and “S_{Y}” using “p^{ID}” so that data are exchanged by “p^{ID}” in each renovation.
M_{X}←M_{X}+p^{ID}(x^{T}x−M_{X}), Y_{X}←Y_{X}+p^{ID}(yx^{T}−Y_{X}),
S_{Y}←S_{Y}+p^{ID}(y²S_{Y}), ←:renovation (144)

COF and “ER” are calculated using “M_{X}”, “Y_{X}” and “S_{Y}”.
COF=M_{X}⁻Y_{X}; ER²=S_{Y}−k^{T}Y_{X} (145)

Each of “M_{X}”, “Y_{X}” and “S_{Y}” is called respectively “tuning matrix”, “tuning vector”, and “tuning deviation”. And the set of “M_{X}”, “Y_{X}”, “S_{Y}” and “N^{ID}” is called “tuning set”, and “x” and “y” are called tuning data. “M_{X}⁻” means the approximate inverse matrix of “M_{X}” when “M_{X}” is not regular, and it means the inverse matrix when “M_{X}” is regular. “ER²” is residual sum of square error divided by “N^{ID}”.
ER²˜Σ_{nεN}E₋ₙ²/N^{ID}, Eₙ=Rₙ−(qR+aC+bD)ₙ
σ²˜Σ_{nεN}E₋ₙ²/(N^{ID}−M^{ID}), M^{ID}=&qab (146)

While the expectation of variance “σ” is standard distribution of error, “ER²” is regarded as the variance when “N^{ID}” is large. “ER” is square root of “ER²”. When the system varies as it elapses, renovation rate must not be extinguished. When “N^{ID}” exceeds fixed value “N^{MAX}”, which is usually set 100˜1000, “N^{ID}” is kept constant “N^{MAX}“ ” (A12). When “N^{ID}” is one, “p^{ID}” is also one and old data become invalid. When data is not completed, “M_{X}” is not regular and inverse matrix “M_{X}⁻¹” cannot be calculated. When man cannot wait till “M_{X}” becomes regular, approximate inverse matrix is calculated. Sweep out method is well known to calculate inverse matrix. When the matrix is not regular, diagonal element(s) exist(s) that is/are 0, even if the row(s) is/are exchanged. In such case(s), the diagonal element(s) is/are remained 0 and the procedure is continued. The matrix, which is calculated by this method, is called approximate inverse matrix. The approximate inverse matrix is of cause the inverse matrix if the matrix is regular. Even if data for “b” are lacked when data for “q” and “a” are completed, “q” and “a” can be calculated by this method. This situation can occur when FF disturbance cannot be caused intentionally and man cannot wait for changing of the disturbance. In this case, “b” is usually regarded, as zero sequence and FF disturbance is not fed forward till “b” is identified.

Least squares method is a very useful art that gives maximum likelihood estimates, but is gives only biased estimator. We consider three points (−1, −1), (0,1) and (1,0) in X-Y coordinate. Since these points locate symmetry to X and Y, the regression line is expected “Y=X”. But the least-squares regression line is “Y=(σ_{XY}/σ_{X}²)X=(½)X”. Correlation coefficient is “σ_{XY}/σ_{X}σ_{Y}=½”. Least-squares estimates are generally biased estimators. They are values multiplied by the absolute value of correlation coefficient. The absolute value of correlation coefficient “k” becomes small when noise is large, and its maximum value is one. Let's consider the case that “k” equals nearly one. Namely noise is small. All “q”, “a” and “b” are least-squares estimated using COFRE.
r=qr+ac+bd (010)

“f” and “g” are nearly equal to true values multiplied by “k” because “q”, “a” and “b” are true values multiplied by “k”.
a=(1−q)f, b=(1−q)g (106)

If “d” is “0” then “c” is calculated true value divided by “k”.
r=fc+gdc=(r−gd)/f (147)

Since “k” is a positive value less than one, calculated “|c|” is larger than true value and excess control is caused. Even if COF is estimated by other method, for example sequence estimation, noise causes excess control in some rate. Excess control induces overshoot. In order to avert this, calculated “c” is multiplied by a reduction factor “k_{RD}”. C₀ is limited in range.
c^{C}₀=k_{RD}c₀, C₀=C₋₁+c^{C}₀, if (C₀<C^{MIN}){C₀=C^{MIN}} else if (C₀>C^{MAX}){C₀=C^{MAX}} (148)

The factor “k_{RD}” can be the above-mentioned absolute value of correlation coefficient “k” when it is calculated. It is almost one but less than one and 0.98˜0.99 in many cases. Man can also determine it by trial and error observing the controlled state. We call this method “distribution of errors”, since this method has been thought out investigating fractions of error.

In settled state, “c” is excited by noise of “r” and noise is amplified by control gain. White noise is considered to obey normal distribution, and seldom to exceed the three times standard deviation “3σ” and almost never to exceed the five times standard deviation “5σ”. The magnification factor “k_{Dis}” is let more than three. Output “c₀” is effectively compressed by (150) only during settled state, and noise is also compressed.
E₀=S_{&a}−R₀, e^{TH}=k_{Dis}r^{ε} (149)
k_{Com}=k_{Res}+(1−k_{Res})E₀²/{E₀²+(e^{TH})^{2}} (150)
c^{C}₀=k_{Com}·c₀, C₀=C₋₁+c^{C}₀, if (C₀<C^{MIN}){C₀=C^{MIN}} else if (C₀>C^{MAX}){C₀=C^{MAX}} (151)

“k_{Res}” is residual compression factor when control error “E₀” is almost 0 namely in settled state, and “k_{Com}” is real compression factor. This method is called noise compression. According to statistics, the standard deviation of the average of M samples is “σ/√(M−1)”. When “k_{Res}” is let “⅓”, noise compression has the effect of average of ten samples in settled state. Therefore “k_{Res}” is usually taken “0.2˜0.4”. This method doesn't increase “&a” and doesn't disturb the settling because it works only in settled state.

Distribution of errors can be combined with noise compression as the following.
E₀=S_{&a}−R₀, e^{TH}=k_{Dis}r^{ε} (149)
k_{CRD}=k_{Com}[k_{Res}+(1−k_{Res})E₀²/{E₀²+(e^{TH})²}] (152)
c^{C}₀=k_{CRD}c₀, C₀=C₋₁+c^{C}₀, if (C₀<C^{MIN}){C₀=C^{MIN}} else if (C₀>C^{MAX}){C₀=C^{MAX}} (153)

“r^{ε}, k_{Com}, k_{Res}, k_{Dis}” are called noise parameters. However both of noise compression and distribution of errors are unnecessary when noise is negligible.

Then parameters are set “k_{Res}=k_{Com}=1”.

We consider the effect of filter. Superscript “L” means the deformation by filter effect. We consider effects of measurement lag or statistical treatments/smoothing (weighted average). The lag and average can be represented as the following, where “R^{L}” is the calculated value, “R” is the true value, “W” is lag or smoothing sequence, and “M” is the degree of the filter.
R^{L}=Σₖ₌₀^{M}WₖΛ^{k}R=Σₖ₌₀^{M}WₖΛ^{k}(qR+aC)=qR^{L}+a^{L}C,
Σₖ₌₀^{M}Wₖ=1, W=Σₖ₌₀^{M}WₖΛ^{k}
a^{L}≡W·a, ∴@a^{L}=1, &a^{L}=&a+M (154)

Thus “&a” is increased by “M”. But “&q” remains constant. We consider a filter to estimate the present value using the measured value. For simplicity, not-weighted filter is taken an example. The controlled variable of “m” periods before is “R-m”. The regression coefficient of the straight line is the following. Bracket “<>” means the mean value.
R^{L}=k(n−<n>)+<R><n>=M/2, <R>=Σₘ₌₀^{M}R₋ₘ/(M+1),
k=6Σₘ₌₀^{M}(2m−M)R^{-m}/M(M+1)(M+2) (155)

The present value is given when “n” is 0.
R^{L}(0)=<R>−k<n>=2Σₘ₌₀^{M}{(2M+1−3m)/(M+1)(M+2)}R₋ₘ (156)

The expression using sequences is the following.
R^{L}=WR=WqR+WaC=qR^{L}+a^{L}C, a^{L}=Wa,
W≡Σₘ₌₀^{M}WₘΛ, Wₘ≡2(2M+1−3m)/(M+1)(M+2)
&a^{L}=&a+&W=&a+M (157)

Thus, even the filter to estimate the present value similarly increases “&a” by “M”. This filter is used in the above-mentioned reference “Sugaku semina”. The reason why “&a” must be more than twenty was the result of high degree filter.

Therefore, the noise reduction art is necessary for FT settling instead of filter.

We consider output lag. There are cases that the calculations time for the manipulated variable is not negligible or that the manipulated variable cannot be changed at one time. The aperture of a pulse valve can be changed only slowly. The temperature should not be changed rapidly in crystal growth. In these cases, the manipulated variable is changed along a zigzag line that connects calculated values of the manipulated variable at each period. The effective output “C^{L}” is the mean value of the neighbored two periods. In stead of a zigzag line, the manipulated variable can be output along a polynomial curve of degree “M” connecting “M+1” past and present data points. As known well, the manipulated variable of these cases is also represented by a filter of degree “M”. “M=1” is the case of a zigzag line.
C^{L}=Σₖ₌₀^{M}WₖΛ^{k}C, Σₖ₌₀^{M}Wₖ=1, W=Σₖ₌₀^{M}ₖΛ^{k}
R=qR+aC^{L}=qR+aWC=qR+a^{L}C
a^{L}≡aW, ∴@a^{L}=1, &a^{L}=&a+M (158)

In these cases, only “&a” is increased by M, too. Avoiding from the increase of the degree, the manipulated variable must be output stepwise as far as possible.

Thus filters increase “&a” and maintains “&q” constant. Even when a filter is used, its degree must be as low as possible.

We consider the effect of dead time. Its effect is similar to a filter of the manipulated variable. In a pipeline system, the response is delayed by the time “M·T” to transport from the manipulated point to the controlled point. COFRE with dead time can be represented by “C” without dead time.
C^{L}=Λ^{M}C, R=qR+aC^{L}=qR+a^{L}C, W=Λ^{M}
a^{L}≡aW, ∴&a^{L}=&a+M

Thus only “&a” is increased by “M”.

All these effects increase only “&a”.

We explain NACS from the viewpoint of robust control. When man consider a control system, the propagator is written as “R=Ψ(C; t)”. The function “Ψ(C; t)” is called representation system in robust control. Man calculates the manipulated variable “C” using the command “S” and the controlled variable “R”. This arithmetic is written in function form “C=Φ(R, S; t)”. The function “Φ(R, S; t)” is called determination system in robust control. Not-NACS art has usually a determination system Φ independent from the representation system Ψ. Ψ is propagation equation and Φ is PID system, for example.
R=Ψ(C; t), C=Φ(R, S; t) (160)

“R”, which is changed by “C”, is calculated by (D.
R=Ψ(Φ(R, S; t);t)=Ξ(R, S; t) (161)

This representation is called a loop propagator. Using “R=Ξ”, it is studied how “R” is approaching to “S”. And it is called “stable” that “R” approaches to finite “R(∞)”. The parameters of the system are so determined that the system is stable.

Let's consider NACS case. The manipulated variable is so calculated that the controlled variable agrees perfectly with the command within a finite delay in the determination system in the system of FT settling. Moreover, Ψ is used in determination system as the inverse function of Φ.
R=Ξ(R, S; t≧&a)=S, Ψ=Φ⁻¹ (162)

Therefore the system is absolutely stable as long as that propagator is correct. An investigation using loop propagator is only fruitful when Ψ is not the inverse function of Φ. Stability of automatic tuning is investigated as Robust-adaptive system.

This system uses the loop propagator combined with the tuning system where parameters of the determination system are identified. And the convergence of the parameters is investigated in the loop including the tuning system. Namely, both of the stability or convergence of the controlled variable and the stability or convergence of the tuning parameters are considers. When both stability are satisfied, the system is called “robust”. The control gain is taken for the stability index of the controlled variable in robust theory. Robust-stability of NACS is examined by the following COFRE.
rₙ=q₁rₙ₋₁+ . . . +q_{&q}r_{n-&q}+a₁cₙ₋₁+ . . . +a_{&a}c_{n&a}+b₁dₙ₋₁+ . . . +b_{&b}d_{n-&b} (120)

Such case is considered that both command and FF disturbance are independently changed and “&qab” sets of tuning data are obtained. Then the data sets are linear independent and COF can be calculated using a kind of reverse function of propagator.
&qab≡&q+&a+&b
x_{nε[&qab]}≡(rₙ₋₁, . . . , r_{n-&q}; cₙ₋₁, . . . , c_{n-&a}; dₙ₋₁, . . . , d_{n-&b})^{T}
X≡(x₁, x₂, . . . , x_{&qab})^{T}, Y≡(r₁, r₂, . . . , r_{&qab})^{T}
COF≡(q₁, . . . , q_{&q}, a₁, . . . , a_{&a}, b₁, . . . , b_{&b})^{T}
Y=X·COF→COF=X⁻¹Y (140)

Here “^{T}” means transpose and “⁻¹” inverse matrix. Thus, as soon as tuning data “X” is completed, COF is identified and determined. Thereafter all COV is the same as or newer than what are used for identification. Therefore NACS is robust in finite time. It depends on only measurement precision.

Thus NACS has no factor of instability by the classical concept. But instability of conventional NACS has been found in fact. Why does the instability occur?

The cause of instability was found that it is based mainly on the precision of COF and proper control period. The controlled variable is settled almost perfectly in a finite time by NACS. Almost all time during control is under settled state. Only noise is observed in settled state. Noise doesn't act under the rule of COFRE. Therefore, no data can be used for tuning in settled state. If many parts of operated data are used for tuning then COF is broken by noise. Therefore only data, in which absolute value of differences “r, c, d” are large, can be used for tuning. Arts against noise mentioned above are useful. Even if COF is identified using good data, not observed disturbance gives error/noise. If its effect is large, good precision of COF cannot be expected. It is very difficult for not-NACS to feed forward the disturbance if it were wanted. Therefore it is usually given up. Any measurable disturbance should be taken in propagator if its effect is large, and it is fed forward. It is harmful for NACS to give up feed forward of measurable disturbance. If control cycle is short, absolute value of differences “r, c, d” become rapidly small and their precision become badly, too. COF given by such data can have very bad precision. Not only bad precision can get, but also new type instability exists. We cannot arrive on the moon surface in one minute from the earth. Similarly a limit interval time exists. We call it “excessively near future”. If man tries to settle in it, the control system is fallen into instability. The settling time is clear in NACS. The condition to calculate must not include such rashness. It leads to proper control period.

We explain feed forward of disturbance concisely.

Disturbances that are caused by program or that can be measured also cause changing of the controlled variable. These disturbances are called measurable disturbances and given a symbol “D”. Though there can be many measurable disturbances in a system, these are represented by only one disturbance for simplicity. A measurable disturbance can be fed forward so that its bad effect is avoided, the controllability is improved, and the identified COF can have better precision. This art is called FF (feed forward).
(s^{N}−Σₙ₌₁^{N}q^{A}ₙs^{N-n})R=(Σₙ₌₁^{N}a^{A}ₙs^{N-n})C+(Σₙ₌₁^{N}b^{A}ₙs^{N-n})D (163)

Supposed not only “C” but also “D” changes stepwise and periodically, the following difference equation D-eq. is derived similarly to mentioned above.
R=qR+aC+bD, q, a, bε(1, N] (164)

Indeed FF disturbance can be varied continuously unless it is caused by program. This continuous variation can be approximated by a polynomial curve of degree “L”. This means that “D” has a filter of degree “L”, and “&b” is increased by “L”. The degree of stepwise variation is 0 and zigzag line variation 1. “L” is called degree of continuity. Since “D” is not generally fed forward in PID control, small “L” value such as 0 or 1 suffices many cases.

Filters for “R” increase “&a” and “&b”, filters for “C” increase “&a”, and filter for “D” increase “&b”. D-eq. and M-eq. of FIG. 3 are changed into F-eq. considering various filtering effects.
R=qR+aC+bD, q, a, bε(1,], &q≦&a, &q≦&b (165)

We must consider the cases “aₙ=0” and “bₙ=0” that accidentally happen.

Then F-eq. is expanded to general COFRE.
R=qR+aC+bD, q, a, bε(1,] (009)

Using the following conversion formula, REFRE is derived.
f=a/(1−q), g=b/(1−q) (167)
R=fC+gD, gε(1,) (103)

When there are M measurable disturbances, COFRE and REFRE are represented as the following.
R=qR+aC+b₁D₁+b₂D₂++b_{M}D_{M} (168)
R=fC+g₁D₁+g₂D₂+ . . . +g_{M}D_{M} (169)
a=(1−q)f, b_{mε[M]}=(1−q)gₘ (170)

We explain excessively near future.

We consider the case of excessively short control period. The main purpose of such case is to make the settling time short. We use a model that is similar to Ziegler-Nichols model and neglect FF disturbance. When control period is short, SREF has a slow rising part or dead time in many cases. Ziegler-Nichols model represents it well. Therefore the rising part “f_{n<M}” before the settling time is regarded as negligible and these are included in “f_{M}”.
f_{n<M}≈0, f_{M}←f₁+f₂+ . . . +f_{M}, impulse response function (193)

We calculate “c”, which makes “r” agree with “s” after M periods.
r_{n≧M}=sₙ=Σ_{i=M}^{n-@c}fᵢcₙ₋ᵢ
s_{M}=f_{M}c₀+f_{M+1}c₋₁+f_{M+2}c₋₂+ . . . +f_{M-@c}c@c
s_{M+1}=f_{M}c₁+f_{M+1}c₀+f_{M+2}c₋₁+ . . . +f_{M-@c+1}c_{@c}
s_{M+2}=f_{M}c₂+f_{M+1}c₁+f_{M+2}c₀+ . . . +f_{M-@c+}2c_{@c} (171)

Because “c_{n<0}” are known, “c_{n≧0}” can be calculated. We, however, suppose that the system have been in stationary state under “S=0, C=0” and “S” is changed now, for simplicity.
c_{n<0}=0, s_{M}≠0, Sn_{>M}=0 (172)
c₀=s_{M}/f_{M},
c₀=−(f_{M+1}/f_{M})s_{M}/f_{M},
c₂=((f_{M+1}/f_{M})²−(f_{M+2}/f_{M}))(s_{M}/f_{M}),
c₃=(−(f_{M+1}/f_{M})³+2(f_{M+1}/f_{M})(f_{M+2}/f_{M})−(f_{M+3}/f_{M}))(s_{M}/f_{M}), (173)

All “cₙ” have a factor “(f_{M+1}/f_{M})ⁿ” and factors of products of (f_{M+n}/f_{M}). Exponential function has an infinite radius of convergence since the coefficients of factors converge to zero rapidly. But the coefficients of factors are integer in this case. The radius of convergence is considered “1 ”. Therefore “cₙ” diverge unless the absolute value of “f_{M}” is the maximum among “fₙ”. When the maximum of “fₙ” is “f_{N}”, “N” is called the peak time. Indeed the calculation method of NACS differs from method. This model indicates that the settling within the peak time can make the system unstable or noisy.

The future interval until the peak time is called “excessively near future”. (FIG. 33)

As mentioned above, NACS is a very precise control system. But there are some problems. When NACS is used for complex system, single pole representation “&q=1” is convenience. But its applicable region is not clear. And “&a” and “&b” cannot be determined theoretically. Moreover, new instability has been found. When the system is controlled by the third strong power that is not fed forward during tuning, the system sometime falls into instability. It is very natural. But, in order that automatic tuning system can substitute the system of wide use without automatic tuning system, this problem must be solved. When controlled machine is repaired, control stops. Bad parts are exchanged, and bad position is mended. After repair, control restarts. But, some accidents happen. Load may become too light, and oscillation begins. Cable may be connected reverse, the system is controlled reverse. If the control is re-tuned, the system goes well without re-repair. Therefore, it is better to re-tune automatically. When the command is changed complicatedly, control error like cusp happens sometime. It is not desirable. It is desirable that control error is as small as possible.

### DISCLOSURE OF THE INVENTION

Counter plans against above-mentioned problem are the following.

A. Degree systemization. (FIG. 12):
&q<6, &a<6, &b<6 or &q=1, &a<10, &b<10 (180)

If control period is proper, each degree of COF is taken less than 6.

If single pole representation is preferred, other degrees are less than 10.

B. FT determining. (FIGS. 1, 2): The manipulated variable “c₀” is calculated under the condition that both of the controlled variable “R” and the manipulated variable become constant in finite periods and that FF disturbance doesn't elongate the settling time.

C. Tuning based on significant digits. (FIG. 17): Tuning is carried out based on preliminary fixed precision (significant digits) of control. At the beginning of re-start, re-tuning cycles (fast phase) are inserted.

We explain about Degree systemization. (FIG. 12)

We have had many experiences suggesting degree systemization without theoretical background. For simplicity, we consider omitting “b” for a while. We call poles of A-system A-poles, and poles of D-system D-poles. We consider the system that energy theorem is satisfied. The real parts of A-poles are negative, and the absolute values of D-poles are smaller than one. Each D-pole “p_{μ}” is represented using real part “−p^{R}_{μ}” and imaginary part “p^{J}_{μ}” of A-pole.
p^{A}_{μ}=−p^{R}_{μ}+j·p^{J}_{μ}, 0<p^{R}_{μ}
p_{μ}=exp(^{j·p}^{J}_{μ}T)exp(−p^{R}_{μ}T) (181)

We consider of the control period “T”. If “p^{A}_{μ}” is real number, then “p_{μ}” is also positive real number. And if “p^{A}_{μ}” is imaginary number, then “p_{μ}” is real number only when “p^{J}_{μ}T” is integer times “π”. This case is special and accidental. Even when a D-pole is real number, it is regarded as an imaginary D-pole if corresponding A-pole is imaginary number. As “T” increases, the absolute values of “p_{μ}” decrease exponentially, so that “p_{μ}” corresponding to “p^{R}_{μ}” can be regarded as zero and neglected. And when “p^{J}_{μ}T” exceeds “2π”, “p^{J}_{μ}T” can not be distinguished with poles of “p^{J}_{μT-}2π”. This phenomenon is well known as sampling theorem. It is said then that observable problem occurs. But its effect is not a problem if system is so made that mean effect during period acts. Mean effect is rapidly decreases as “p^{H}_{μ}T” approaches “2π”. Finally, real M poles remains.
1−q≈π_{μ=1}^{M}(1−p_{μ}Λ) (182)

We consider this state by the differential equation. That the period “T” is increased in D-system is equivalent that changing in the interval shorter than “T” is neglected in A-system. And that D-poles asymptote to zero corresponds to that real parts of A-poles diverge to −∞.
R(s)={a^{A}(s)/p^{A}(s)}C(s)=f(s)C(s); f(s)≡a^{A}(s)/p^{A}(s)
p^{A}(s)≡π_{μ=1}^{M}(s−p^{A}_{μ})^{Kμ}; Σ_{μ=1}^{M}K_{μ=N}
a^{A}(s)≡a^{A}_{N}π_{μ=1}^{N′}(s−a^{A}_{μ}) (088)

A-eq. must be divided by all common poles to be irreducible. It is called degeneration that the degree of the differential equation decreases by the generation of a new common pole. Imaginary poles disappear in conjugation couple. We investigate the case that real part of “p^{A}_{μ}”becomes to −∞ as “T” increases. A-eq. is divided by “(−1)^{N}q^{A}_{N}=Σ_{μ=1}^{N}p^{A}_{μ}” so that the constant term becomes “1”.
p*(s)R^{A}(s)=a*(s)C^{A}(s)
p*(s)=1+Σₙ₌₀^{N-1}p*ₙs^{N-n=π}_{μ=1}^{N}{1−(s/p^{A}_{μ)}}
a*(s)=Σₙ₌₁^{N}a*ₙs^{N-n}=a*_{Nπ}_{μ=1}^{N-1}{1−(s/a^{A}_{μ})} (183)

When one “p^{A}_{μ}” exists, which diverges to −∞, the degree of “p*(s)” decreases by one (∵(1/p^{A}_{μ)→}0), and the degree of “a*(s)” also decreases by one because of integral condition. Namely, one “1/a^{A}_{μ}” becomes 0. In the same time, one common factor “(1−p_{μ}Λ)=(1−a_{μ}Λ), p_{μ}=a_{μ}=0” is generated in C-eq., the degree of C-eq. decreases by one, and both degrees of A-eq. and C-eq. keep the same.
{π_{μ=1}^{L}(1−p_{μ}Λ)}R=a₁{π_{μ=1}^{L-1}(1−a_{μ}Λ)}C (184)

Thus the degree of C-eq. decreases while the control period becomes long. When only one real pole remains, C-eq. itself is single pole representation. It is a trivial case. Therefore we consider the case that more than two real poles remain. When L poles remain, the system is called lag of order L. If variation exists among poles, small poles can be neglected when the control period is elongated a little.

Therefore, remained poles can be considered to have almost the same value.
p_{μ}=exp(p_{μ}^{A}T), p¹_{μ,k}≡{n^{k}p_{μ}ⁿ}_{[1,)}, f=Σₖ₌₀^{L-1}k_{μ,k}, p¹_{μ,k}, 1−q=(1−p_{μ}Λ)^{L} (185)

Maximal delay/lag occurs when “k_{μ,k<L-1}=0, k_{μ,L-1}=1”. We consider the case.

The maximum order of “p^{I}_{μ}” is about “−(m−1)/log(p_{μ})”.

All characteristic functions “p^{I}_{μ}” decrease at the right side of “−(L−1)/log(p_{μ)”.}

We make the settling period “&a=L” to locate the right side of the peak.
−(L−1)/log(p_{μ})≦L, p_{μ}≦e^{-(L-1)/L}>1/L
L=2→p_{μ}≦0.61, L=3→p_{μ}≦0.51, L=4→p_{μ}≦0.47
L=5→p_{μ}≦0.45, L=6→p_{μ}≦0.43, L=∞→p_{μ}≦0.368 (186)

The decrement part of single pole representation is described by simple exponential function. The decrement part of lag of order L is not simple exponential function. As L increases, the decrement part becomes complicated. The condition (186) is concerning excessively near future. But we have one more condition concerning energy theorem. Energy theorem is represented as the following in single pole representation.
q₁<1 (187)

As “q₁” is assumed small, necessary degree of COF decreases. Therefore we calculate the worst case (188).
q₁=L·p_{μ}≈1, p_{μ}≈1/L, L≧2 (188)
R=qR+aC, &q=&a=L, 1−q=(1−p_{μ}Λ)^{L} (189)
(1−q_{L1}Λ)R=a_{L}C (190)

We try to approximate (189) to (190). if “U_{L}” can be approximated to RFS, “a_{L}” can be also approximated to RFS. Then single pole representation approximation is possible.
a_{L}≡a(1−q_{L1}Λ)/(1−p_{μ}Λ)^{L}=a(1−U_{L}), @U_{L}=1 (191)
if U_{L}≈uε(1, L]→a_{L}≈a′≡a(1−u)ε(1, &a+L], (1−q_{L1}Λ)R≈a′C (192)
U_{L}≡1−(1−q_{L1}Λ)/(1−p_{μ}Λ)^{L}
=1−(1−q_{L1}Λ)Σₙ₌₁^{+∞}(L+n−1)!(p_{μ}Λ)ⁿ/(L−1)!n!
=−Σₙ₌₁_{+∞}{(L+n−1)!(p_{μ}Λ)ⁿ/(L−1)!n!−(q_{L1}/p_{μ})(L+n−1)!(p_{μ}Λ)ⁿ⁺¹/(L−1)!n!} (193)
g_{L}=Lq_{L1}/q₁=q_{L1}²=p_{μ} (194)
U_{L}=−Σₙ₌₁^{+∞}{(L+n−1)!(p_{μ}Λ)ⁿ/(L−1)!n!−(L+n−2)!(p_{μ}Λ)ⁿ/(L−1)!(n−1)!}
=−Σₙ₌₁^{+∞}{(L+n−1)!(p_{μ}Λ)ⁿ/(L−1)!n!−n(L+n−2)!(p_{μ}Λ)ⁿ/(L−1)!n!}
=−Σₙ₌₁⁺²⁸ (L+n−1−g_{L}n)(L+n−2)!(p_{L}Λ)ⁿ/(L−1)!n! (195)

“U_{L}” and “q_{L1}” are calculated as the following for “L=2˜10” under the condition “q₁=1” and “g_{L}” are (196). [FIG. 32]
g₂=1.5, g₃=1.6, g₄=1.6, g₅=1.6, g₆=1.6,
g₇=1.6, g₈=1.6, g₉=1.6, g₁₀=1.6 (196)
q₂₁=0.75, q₃₁=0.53, q₄₁=0.40, q₅₁=0.32, q₆₁=0.27,
q₇₁=0.23, q₈₁=0.20, q₉₁=0.18, q₁₀₁=0.16 (197)
U₂={0.250, 0.000, −0.062, −0.062, −0.047, −0.031, −0.020, −0.012, −0.007, . . . }_{[1,)}
U₃={0.467, 0.133, 0.015, −0.012, −0.012, −0.008, −0.004, −0.002, −0.001, . . . }_{[1,)}
U₄={0.600, 0.225, 0.063, 0.012, −0.000, −0.001, −0.001, −0.000, −0.000, . . . }_{[1,)}
U₅={0.680, 0.280, 0.088, 0.022, 0.004, 0.001, −0.000, −0.000, −0.000, . . . }_{[1,)}
U₆={0.733, 0.317, 0.104, 0.028, 0.006, 0.001, 0.000, 0.000, −0.000, . . . }_{[1,)}
U₇={0.771, 0.343, 0.114, 0.031, 0.007, 0.002, 0.000, 0.000, 0.000, . . . }_{[1,)}
U₈={0.800, 0.363, 0.122, 0.034, 0.008, 0.002, 0.000, 0.000, 0.000, . . . }_{[1,)}
U₉={0.822, 0.378, 0.128, 0.035, 0.008, 0.002, 0.000, 0.000, 0.000, . . . }_{[1,)}
U₁₀={0.840, 0.390, 0.132, 0.036, 0.008, 0.002, 0.000, 0.000, 0.00, . . . }_{[1,)} (198)

Namely with precision of 6% for lag of order 2, with precision of 2% for order 3˜4, “U_{L}” can be approximated by RFS of degree “&U_{L}=&q−1”.

Then “&a_{L=&a+&U}_{L}”. Since “&q_{L}=1”, “&a_{L}+&q_{L}” agrees with “&qa”.
L≦4→&qa=&a_{L}+&q_{L} (199)

With precision of 1% for lag of order higher than “4”, “U_{L}” can be approximated by RFS of degree “4”.
5≦L→&U_{L}=4 (200)

We notice that almost all “U_{L}>4” resemble each other. Considering integral condition, this result suggests “q” and “a” can be approximated by RFS of low degree. We consider the case that “L” is let infinite.
lim(L→∞)qₙ=lim(L→∞)(−q₁/L)ⁿL!/(L−n)!n!=−(−q₁)ⁿ⁺¹/n! (201)
∴qₙ=(−q₁)ⁿ⁺¹/n!, q=1−exp(−q₁Λ), @q=1 (202)
q={q₁, −q₁²/2, q₁³/6, −q₁⁴/24, q₁⁵/120, −q₁⁶/720, . . . }_{[1)} (203)

“q” can be approximated by RFS of degree 5 with the precision of 1%. Thus “a” is approximated by RFS of degree 5. It is considered common for degeneration.

The degree of difference equation can be less than “6”.
T is proper, no filter→L<6 (204)

The result agrees with our experience. We try the single pole approximation.
1−q=Σₙ₌₀^{+∞}(−q₁Λ)ⁿ/n!=exp(−q₁Λ) (205)
(1−q_{∞1}Λ)R=a(1−q_{∞1}Λ) exp(q₁Λ)C=a_{∞}C (206)
a_{∞}≡a(1−q_{∞1}Λ)exp(q₁Λ)=a(1−U_{∞}) (207)
U_{∞}≡1−(1−q_{∞1}Λ)exp(q₁Λ), g_{∞≡q}_{∞1}/q₁ (208)

$$\begin{matrix}{U}_{\underline{∞}} = 1 - ( 1 - {q}_{\underline{∞} 1} Λ ) {\underline{\sum }}_{n = 0}^{+ ∞} {( {q}_{1} Λ )}^{n} / n ! \\ = - {\underline{\sum }}_{n = 1}^{+ ∞} {( {q}_{1} Λ )}^{n} / n ! + {g}_{\underline{∞}} {\underline{\sum }}_{n = 1}^{+ ∞} {( {q}_{1} Λ )}^{n + 1} / n ! \\ = - {\underline{\sum }}_{n = 1}^{+ ∞} {( {q}_{1} Λ )}^{n} / n ! + {g}_{\underline{∞}} {\underline{\sum }}_{n = 1}^{+ ∞} {n ( {q}_{1} Λ )}^{n} / n ! \\ = {\underline{\sum }}_{n = 1}^{+ ∞} ( {g}_{\underline{∞}} n - 1 ) {( {q}_{1} Λ )}^{n} / n !\end{matrix} \qquad ( 209 )$$

@U_{∞}=1 (210)

We have get the following result under the condition “g_{∞}=1.25”, “q₁=0.8” and “q_{∞1}=1”.
U_{∞}={0.2, 0.47, 0.235, 0.068, 0.014, 0.002, 0.000, 0.000, . . . }_{[1,)} (211)

“U_{∞}” can be also approximated by RFS of degree 4 with precision of 2%. Therefore the degree of “a_{∞}” is 9. This result is applicable to the case “L≧5”. “&b” is considered the same as “&a” when filter effect is negligible.

The system can be approximated by single pole representation.
T is proper, no filter→L<6, &q=1, &a=2L−1, &b=2L−1 (212)

We call this equation N-eq. Of course, the degree of COF depends on the precision of approximation. The precision of the approximation of the above expression is selected so that the representation becomes simple. When many measurable disturbances are fed forward and when the degree of differential equation is higher than “2”, total terms of “q”, “a” and “b” becomes large, so that N-eq. is not recommended. Corresponding D-eq. has much less terms.

The measurable disturbance can be one bit data or low precision data. In many cases degree of continuity is taken 0.

We expatiate on FT determining. In the previous art, the range of “S” and “D” used is extended to “&qa” periods after. We consider REFRE.
r=fc+gd (213)

Since “f” is not an FS, “r” cannot be usually an FS even if “c” is an FS and “d” is 0.

FT settling doesn't result from FT manipulating.

We consider COFRE next.
r=qr+ac+bd (010)
∴c={(1−q)r−bd}/a (214)

We suppose the case “r” is an FS and “d” is 0, both “(1−q)r−bd” and “a” are RFS. However the quotient cannot be a RFS usually, it is usually an infinite sequence.

FT manipulating doesn't result from FT settling.

If perfectly stable system is expected, then both of FT settling and FT manipulating namely

FT determining must be satisfied.

Thus we seek the solution, which satisfies the condition that each of “r”, “c” and “d” is a finite sequence.

It is usually undesirable that the settling time is delayed by “D”. The following condition is added to the above condition.

“D” does not disturb the settling.
&ac≧&bd∴&a+&c≧&b+&d (215)
(1−q)r=ac+bd (010)

The end orders of the both sides are same.
&((1−q)r)=&q+&r=&(ac+bd)=&a+&c (216)
&r=&a+&c−&q, &d≦&a+&c−&b=&q+&r−&b (217)
r=qr+ac+bd (010)

At present time, “r_{n≦0}, c_{n<0}” are measured, i.e. exist. We consider when manipulation is finished “c_{n>&c}=0” and effect of disturbance ceases “(bd)_{n>&bd}=0”.
r_{n>&ac}=q₁rₙ₋₁+q₂rₙ₋₂+ . . . +q_{&q}r_{n-&q}, c_{n>&c}=0, (bd)_{n>&bd}=0” (218)

If “rₙ₋₁, rₙ₋₂, . . . , r_{n-&q}” are all 0, “r_{n>&ac}” is also 0. Namely, if a set of “c₀, c₁, . . . , c_{&c}” makes “rₙ₋₁, rₙ₋₂, . . . , r_{n-&q}” 0, then FT determining realizes.
r_{0<n≦&r}=(qr+ac+bd)ₙ
0=(qr+ac+bd)_{n>&r, n≦&ac}, &bd≦&ac (219)

But “R” must settle “S”.
R_{&q}=R₀+r₁+r₂+ . . . +r_{&r}=S_{&q} (220)

Unknowns are “r₁, r₂, . . . , r_{&r}” and “c₀, c₁, . . . , c_{&c}”, the total number is “&r+&c+1”.

Equations are (219) and (220), the total number is “&ac+1”. Both total numbers must meet.
&r+&c+1=&ac+1 (221)
∴
&r=&a, &c=&q, &d≦&a+&q−&b (222)

Thus even when the future data “s_{n>&a}” or “d_{n>&qa-&b}” are available, all must be neglected and regarded as “0” under the condition of FT determining. And the settling time becomes “&a”.

But “R” can be accidentally settled before the settling time.
s_{n>&a}=0, c_{n>&q}=0, d_{n>&d}=0, &d≦&q+&a−&b (223)
R_{n≧&a}=S_{&a}, C_{n≧&q}=C_{n≧&q}, D_{n≧&d}=D_{&d}, &d≦&qa−&b (224)

This solution satisfies the following expression unless new conditions are added such as new command “s_{n>&a}≠0” or new disturbance “d_{n>&qa-&b}≠0”.
c=(r−qr−bd)/a (225)
C=(R−qR−bD)/a (226)

Namely the solution is strict and the result “C” is the same in any period unless the condition is altered. But the solution of previous art is not strict. It doesn't satisfies the above expression even when new conditions, such as new command “s_{n>&qa}≠0” or new disturbance “d_{n>&qa}≠0”, are not given as long as “s_{n>&a}≠0” or “d_{n>&qa-&b}≠0”. The characteristics of (225) and (226) is that variables in the right side is determined satisfying FT determining.

What difference is between FT determining and previous NACS art?

We have investigated this by simulation and real operation. The result is the following (FIG. 8). When “S” is changed stepwise, obvious deviation with two sharp peaks is observed in the curve of not FT determining namely previous art (curve 1), but no such peak are observed in the curve of FT determining (curve 2). Only delay caused by the limitation of “C” and propagation speed is observed. But when “S” is changed continuously along the polynomial of degree five, obvious difference is not observed.

Therefore such extension may be allowable unless the command is not changed stepwise.

On the other hand, even when “D” is changed continuously along the polynomial of degree five, a slight difference is observed between them. And when “D” is changed stepwise (FIG. 7), obvious deviation is observed in not FT determining curve (curve 1), but only slight deviation caused by the limitation of “C”, by the difference between “a” and “b”, and by the propagation speed is observed in FT determining curve (curve 2).

Thus the condition of FT determining improves the control precision clearly.

We explain the solution of FT determining.

We consider the solution using (010) at first.
r=qr+ac+bd (010)

Unknowns are “r₁, r₂, . . . , r_{&a}; c₀, c₁, . . . , c_{&q}”. The first simultaneous equation to be solved is the following. (FIG. 2)
r₁+r₂+ . . . +r_{&a}=S_{&a}−R₀, rₘ=(qr+ac+bd)ₘ, m=1, 2, . . . , &q+&a
r_{m>&a}=c_{m>&q}=d_{m>&d}=0 (227)

Let's solve COFRE and find the formula of the solution.

COV is classified as the following.
r=r^{O}+r^{K}+r^{U}, c=c^{O}+c^{K}+c^{U}, d=d^{O}+d^{K}
&r^{O}=−&q, @r^{K}=1−&q, &r^{K}=0, @r^{U}=1, &r^{U}=&a
&c^{O}=−&a, @c^{K}=1−&a, &c^{K}=−1, @c^{U}=0, &c^{U}=&q
&d^{O}=−&b, @d^{K}1−&b, &d^{K}=&d≦&q+&a−&b (228)
R=R^{O}+R^{K}+R^{U}+S^{D}, C=C^{O}+C^{K}+C^{U}, D=D^{O}+D^{K},
S^{D}≡S_{&a}Λ^{&a}Σ, C^{D}_{n≧&q}=C_{&q}, D^{K}_{n≧&d}=D_{&d}
&R^{O}=−&q, @R^{K}=1−&q, &R^{K}=0, R^{U}=1, &R^{U}=&a−1, @S^{D}=&a
&C^{O}=−&a, @C^{K}=1−&a, &C^{K}=−1, @C^{U}=0
&D^{O}=−&b, @D^{K}=1−&b (229)

“R^{O}”, “C^{O}”, “D^{O}”, “r^{O}”, “c^{O}” and “d^{O}” are old data, which are not used for calculation of “c₀” or “C₀”. “R^{K}”, “C^{K}”, “D^{K}”, “r^{K}”, “c^{K}” and “d^{K}” are data, which are used as known quantities. “R^{U}”, “C^{U}”, “r^{U}”, and “c^{U}” are data, which are used as unknown quantities. “D” and “d” have no data as unknowns and “S^{D}” is the part of the command to be settled under FT determining.

We define two sequences for convenience” sake.
p≡1−q, P≡Σp=Σ−Q (230)

Unknown quantities are arranged in the left side and known quantities are arranged in the right side. The equation in matrix form is the following. (FIG. 18-22)
mx=e, &qa≡&q+&a, i, jε[&qa+1]
x≡(c₀, c₁, . . . , c_{&q}, r₁, r₂, . . . , r_{&a})^{T}, e≡k(S_{&a}−R₀)−qr^{K}−ac^{K}−bd^{K}
r^{K}≡(r₀, r₋₁, . . . , r_{1-&q})^{T}, c^{K}≡(c₋₁, c₋₂, . . . , c_{1-&a})^{T},
d^{K}≡(d_{&qa-&b}, . . . , d₁, d₀, d₋₁, . . . , d_{1-&b})^{T}, (d_{n>&d}=0) (231)
m_{iε[&qa],jε[&q+1]}≡aᵢ₋ⱼ₊₁, m_{iε[&qa]jε[&q+2,&qa+1]}≡−p_{i-j+&q+1},
m_{&qa+1,jε[&q+1]}≡0, m_{&qa+1,jε[&q+2,&qa+1]}≡1
k_{iε[&qa]}≡0, k_{&qa+1}≡1
q_{iε[&qa],kε[&q]}≡qᵢ₊ₖ₋₁, q_{&qa+1,kε[&q]}≡0,
a_{iε[&qa],kε[&a-1]}≡aᵢ₊ₖ, a_{&qa+1,kε[&a-1]}≡0,
b_{iε[&qa],kε[&qa]}≡b_{i+k-&qa+&b-1}, b_{&qa+1,kε[&qa]}≡0,
(Attention! p_{n<0}=p_{>&q}=a_{n<1}=a_{n>&a}=b_{n<1}=b_{n>&b}=0) (232)

Using the first row of the inverse matrix of “m”, “c₀” is represented as the following.
c₀=Σ_{iε[&qa+1]}m⁻¹_{1,i}eᵢ=Σ_{iε[&qa+1]}m⁻¹_{1,i}(k(S_{&a}−R₀)−qr^{K}−ac^{K}−bd^{K})ᵢ (233)

This formula is changed into the difference equation letting the coefficients of “S_{&a}, r₋ᵢ, c₋ᵢ, d₋ᵢ” be “k′₀, q′ᵢ, a′ᵢ, b′ᵢ”. While terms limit COV to known quantities, super scripts are omitted.
c=k′(Λ^{-&a}S−R)+q′r+a′c+b′d
k′₀=Σᵢ₌₁^{&qa+1}m⁻¹_{1,i}kᵢ, q′ⱼ=Σᵢ₌₁^{&qa+1}m⁻¹_{1,i}q_{i,j},
a′ⱼ=Σᵢ₌₁^{&qa+1}m⁻¹_{1,i}a_{i,j}, b′_{&b-j}=Σᵢ₌₁^{&qa+1}m⁻¹_{1,i}b_{i,j} (234)
@k′=&k′=0, @q′=0, &q′=&q−1, @a′=1, &a′=&a−1,
@b′=&b−&qa, &b′=&b−1 (235)

Each of “k′, q′, a′, b′” is a finite sequence. Thus “c₀” is directly calculated using raw data solving directly COFRE under the condition of FT determining. Amended by noise compression and/or error distribution, C₀ is limited in range. C₀ is output. Of course, the amendment and/or “D” can be omitted if desired.
c^{C}₀=k_{CRD}·c₀, C₀=C₋₁+c^{C}₀, if (C₀<C_{MIN}){C₀=C^{MIN}} else if (C₀>C^{MAX}){C₀=C^{MAX}} (153)

We consider the solution using (009). (FIG. 1)
R=qR+aC+bD, q, a, bε(1,] (009)

We solve (237) under the condition of FT determining.
Rₘ=(qR+aC+bD)ₘ, m=1, 2, . . . , &q+&a (237)

The coefficients of “C_{&q}” and “D_{&d}” must be paid attention while “C_{n>&q}=C_{&q}” and “D_{n>&d}=D_{&d}”.

$$\begin{matrix}{R}_{m} = {\underline{\sum }}_{i} {q}_{m - i} {R}_{i} + {\underline{\sum }}_{i} {a}_{m - i} {C}_{i} + {\underline{\sum }}_{i} {b}_{m - i} {D}_{i} \\ = {\underline{\sum }}_{i} {q}_{i} {R}_{m - i} + {\underline{\sum }}_{i < \& q} {a}_{m - i} {C}_{i} + {\underline{\sum }}_{i \geq \& q} {a}_{m - i} {C}_{i} + {\underline{\sum }}_{i < \& d} {b}_{m - i} {D}_{i} + {\underline{\sum }}_{i \geq \& d} {b}_{m - i} {D}_{i} \\ = {\underline{\sum }}_{i} {q}_{i} {R}_{m - i} + {\underline{\sum }}_{i < \& q} {a}_{m - i} {C}_{i} + {A}_{m - \& q} {C}_{\& q} + {\underline{\sum }}_{i < \& d} {b}_{m - i} {D}_{i} + {B}_{m - \& d} {D}_{\& d}\end{matrix} \qquad ( 238 )$$

Let's check the terms after settled.
R_{n≧&qa}=S_{&a}, (qR)_{n≧&qa}=Σᵢ₌₁^{&q}qᵢRₙ₋ᵢ=S_{&a}Σᵢ₌₁^{&q}qᵢ=Q_{&q}S_{&a}
(aC)_{n≧&qa}=Σᵢ₌₁^{&a}aᵢCₙ₋ᵢ=C_{&q}Σᵢ₌₁^{&a}aᵢ=A_{&a}C_{&q}
(bD)_{n≧&qa}=Σᵢ₌₁^{&b}bᵢDₙ₋ᵢ=D_{&d}Σᵢ₌₁^{&b}bᵢ=B_{&b}D_{&d} (239)

Equations represented by (237) of the orders that are higher than or equal “&qa” are all the same equation.
S_{&a}=Q_{&q}S_{&a}+A_{&a}C_{&q}+B_{&b}D_{&d} (240)
C_{&q}={(1−Q_{&q})S_{&a}−B_{&b}D_{&d}}/A_{&a}

From (241), the final constant value “C_{&q}” is obtained. And additional condition such as (220) is unnecessary because (241) contains “S_{&a}”. We arrange unknowns in the left side and known quantities in the right side in a matrix form. (FIG. 23-27)
MX=E, X≡(C₀, C₁, . . . , C_{&q}, R₁, R₂, . . . , R_{&a-1})^{T}
E≡KS_{&a}−QR^{K}−AC^{K}−BD^{K}, R^{K}≡(R₀, R₋₁, . . . , R_{1-&q})^{T},
C^{K}≡(C₋₁, C₋₂, . . . , C_{1-&a})^{T}, D^{K}≡(D_{&qa-&b}, . . . , D₁, D₀, D₋₁, . . . , D_{&b-1})^{T}, (242)
M_{iε[&qa],jε[&q]}≡aᵢ₋ⱼ₊₁, M_{iε[&qa],jε[&q+1]}≡Aᵢ₋ⱼ₊₁,
M_{iε[&qa],jε[&q+2,&qa]}≡−p_{i-j+&q+2}, K_{iε[&qa]≡P}_{i-&a},
Q_{iε[&qa],kε[&q]≡q}ᵢ₊ₖ₋₁, A_{iε[&qa],kε[&a-]}≡aᵢ₊ₖ,
B_{iε[&qa],1}≡B_{i-&qa+&b-1}, B_{iε[&qa],kε[2,&qa]}≡b_{i+k-&qa+&b-2}
(Attention! p_{n<0}=p_{>&q}=a_{n<1}=a_{n>&a}=b_{n<1}=b_{n>&b}=0
P_{n<0}=0, A_{n<1}=0, B_{n<1}=0) (243)

Using the first row of the inverse matrix of “M”, “C₀” is given as the following.
C₀=Σᵢ₌₁^{&qa}M⁻¹_{1,i}Eᵢ=Σ₁₌₁^{&qa}M⁻¹_{1,i}(KS_{&a}−QR^{K}−AC^{K}−BD^{K})ᵢ (244)

This formula is also changed into the difference equation letting the coefficients of “S_{&a}, R₋ᵢ, C₋ᵢ, D₋ᵢ” be “K′₀, Q′ᵢ, A′ᵢ, B′ᵢ”. Each of “K′, Q′, A′ and B′” is a finite sequence. While terms limit COV to known quantities, super scripts are omitted.
C=K′Λ^{-&a}S+Q′R+A′C+B′D
K′₀=Σᵢ₌₁^{&qa}M⁻¹_{1,i}Kᵢ, Q′ⱼ=Σᵢ₌₁^{&qa}M⁻¹_{1,i}Q_{i,j},
A′ⱼ=Σᵢ₌₁^{&qa}M⁻¹_{1,i}A_{i,j}, B′_{&b-j=Σ}ᵢ₌₁^{&qa}M⁻¹_{1,i}B_{i,j} (245)
@K′=&K′=0, @Q′=0, &Q′=&q−1, @A′=1, &A′=&a−1,
@B′=&b−&qa, &B′=&b−1 (246)

Thus “C₀” is directly calculated using raw data solving directly COFRE under the condition of FT determining. C₀ is amended by noise compression and/or error distribution and is limited in range. And it is out put.
c^{C}₀=k_{CRD}·(C₀−C₋₁), C₀=C₋₁+c^{C}₀, if (C₀<C^{MIN}){C₀=C^{MIN}} else if (C₀>C^{MAX}){C₀=C^{MAX}} (247)

Of course, the amendment and/or “D” can be omitted if desired.

(234) and (245) can be deformed multiplied by “Σ” or “Δ”.
C=k′(Λ^{-&a}σ−ρ)+q′R+a′C+b′D, σ≡S, ρ≡ΣR (248)
c=K′Λ^{-&a}s+Q′r+A′c+B′d (249)

(248) can be applied for position control when (245) is applied for speed control for example. Similarly (249) can be applied for speed control when (234) is applied for position control. Thus NACS is applicable to complex system, which have plural commands. Position control, where speed is limited, is an example.
c=k′(Λ^{-&a}S−R)+q′r+a′c+b′d
C=k′(Λ^{-&a}σ−ρ)+q′R+a′C+b′D
C=K′Λ^{-&a}S+Q′R+A′C+B′D
c=K′Λ^{-&a}s+Q′r+A′c+B′d (249)

We call “k′, q′, a′, b′; K′, Q′, A′, B′” MAF (Manipulation function), the above four equations MAFRE (MAF representation). When the system or subsystem is not complex between difference and sum, the first form of (249) is recommended. The form has integral effect so that nonlinearity or deviation of original point of “R” or “C” is automatically corrected. Both “K” and “k” correspond to control gain.

It is written in several textbooks of control technology that finite time settling has a larger gain than PID. We argue that it is wrong in NACS as long as the control period is proper. For comparison's sake between PID and NACS, let's calculate MAF in the case of Ziegler-Nichols model when “T” is “KT_{L}”.
&q=1, &a=2, &b=3; q₁=exp(−s₀KT_{L})≈1, q_{n≦0}=q_{n>1}=0;
a₁=0, a₂=KT_{L}, a_{n≦0}=a_{n>2}=0,; b_{n≦0}=b_{n>3}=0; (250)
&a+&q+1=4, x≡(c₀, c₁, r₁, r₂)^{T}
m_{1,1}=a₁, m_{1,2}=a₀=0, m_{1,3}=p₀=−1, m_{1,4}=p₋₁=0,
m_{2,1}=a₂, m_{2,2}=a₁, m_{2,3}=−p₁=q₁, m_{2,4}=p₀=−1,
m_{3,1}=a₃=0, m_{3,2}=a₂, m_{3,3}=q₂=0, m_{3,4}=q₁,
m_{4,1}=0, m_{4,2}=0, m_{4,3}=1, m_{4,4}=1,
m⁻¹_{1,1}=(a₂+q₁A₂)/A₂(a₂+q₁a₁), m⁻¹_{1,2}=a₂/A₂(a₂+q₁a₁),
m⁻¹_{1,3}=−a₁/A₂(a₂+q₁a₁), m⁻¹_{1,4}=1(a₂+q₁a₁), (251)

We calculate MAF by (232).
k′₀=m⁻¹_{1,4}=1/(a₂+q₁a₁)=1/KT_{L},
q′₀=−q₁m⁻_{1,1}=−q₁(a₂+q₁A₂)A₂(a₂+q₁a₁)=−q₁(1+q₁)/KT_{L},
a′₁=−a₂m⁻¹_{1,1}=−a₂(a₂+q₁A₂)/A₂(a₂+q₁a₁)=−(1+q₁),
b′₀={(1+q₁)b₁+b₂}/KT_{L}, b₁={(1+q₁)b₂+b₃}/KT_{L},
b′₂=(1+q₁)b₃/KT_{L},
c₀=k′₀(S₂−R₀)+q′₀r₀+a′₁c₋₁+b′₀d₀+b′₁d₋₁+b′₂ d₋₂ (252)

Instead of using matrix, we solve simultaneous equation.
R₁=q₁R₀+a₁C₀+a₂C₋₁+b₁D₀+b₂D₋₁+b₃D₋₂
R₂=q₁R₁+a₁C₁+a₂C₀+b₁D₁+b₂D₀+b₃D₋₁
R₃=q₁R₂+a₁C₂+a₂C₁+b₁D₂+b₂D₁+b₃D₀ (253)

We consider (243) and solve COFRE.
R₁=q₁R₀+a₁C₀+a₂C₋₁+b₁D₀+b₂D₋₁+b₃D₋₂
S₂=q₁R₁+a₁C₁+a₂C₀+b₀D₀+b₂D₀+b₃D₋₁
S₂=q₁S₂+a₁C₁+a₂C₁+b₁D₀+b₂D₀+b₃D₀ (254)
R₁=q₁R₀+a₁C₀+a₂C₋₁+b₁D₀+b₂D₋₁+b₃D₋₂
a₂C₀=S₂−q₁R₁−a₁C₁−B₂D₀−b₃D₋₁
C₁={(1−q₁)S₂−B₃D₀}/A₂ (255)

$$\begin{matrix}{a}_{2} {C}_{0} = {S}_{2} - {q}_{1} ( {q}_{1} {R}_{0} + {a}_{1} {C}_{0} + {a}_{2} {C}_{- 1} + {b}_{1} {D}_{0} + {b}_{2} {D}_{- 1} + {b}_{3} {D}_{- 2} ) - {a}_{1} \{ 1 ( 1 - {q}_{1} ) {S}_{2} - {B}_{3} {D}_{0} \} / {A}_{2} - {B}_{2} {D}_{0} - {b}_{3} {D}_{- 1} & ( 256 ) \\ ( {a}_{2} + {q}_{1} {a}_{1} ) {C}_{0} = \{ {A}_{2} - {a}_{1} ( 1 - {q}_{1} ) \} {S}_{2} / {A}_{2} - {q}_{1}^{2} {R}_{0} - {q}_{1} {a}_{2} {C}_{- 1} - ( {q}_{1} {b}_{1} - {a}_{1} {B}_{3} / {A}_{2} + {B}_{2} ) {D}_{0} - ( {q}_{1} {b}_{2} + {b}_{3} ) {D}_{- 1} - {q}_{1} {b}_{3} {D}_{- 2} & ( 257 ) \\ {C}_{0} = {S}_{2} / K {T}_{\underline{L}} - {q}_{1}^{2} {R}_{0} / K {T}_{\underline{L}} - {q}_{1} {C}_{- 1} - ( {q}_{1} {b}_{1} + {B}_{2} ) {D}_{0} / K {T}_{L} - ( {q}_{1} {b}_{2} + {b}_{3} ) {D}_{- 1} - {q}_{1} {b}_{3} {D}_{- 2} & ( 258 )\end{matrix}$$

K′₀=1/KT_{L}, Q¹₀=−q₁²/KT_{L}, A′₁=−q₁,
B′₀=−(q₁b₁+b₁+b₂)/KT_{L}, B′₁=−(q₁b₂+b₃), B′₂=−q₁b₃
C₀=K′₋₂S₂+Q′₀R₀+A′₁C₋₁+B′₀D₀+B′₁D₋₁+B′₂D₋₂ (259)
By the way, PID constants by Ziegler-Nichols' method are the following.
C=k_{P}(E+k_{I}∫₀^{t}Edt+k_{D}(dE/dt)), E≡S−R (260)

P-control: k_{P}=1/KT_{L}, k_{I}=k_{D}=0

PI-control: k_{P}=0.9/KT_{L}, k_{I}=1/3.3T_{L}≈0.3/TL, k_{D}=0

PID-control: k_{P}=1.2/KT_{L}, k_{I}=0.5/T_{L}, k_{D}=0.5 T_{L}

We find control gains “k′”, “K′”, and “k_{P}” are nearly the same. Therefore both noise levels are similar when PID has no filter and NACS is without noise compression.

Control gains are inversely proportional to “KT_{L}” that is control period of NACS.

We guess that this misunderstand is caused by bad system model and shorter control period. And very long integral time constant saves PID.

Manipulated variable “c₀” can be calculated under FT determining by deforming previous art.
s_{n>&a}=0, c_{n>&q}=0, d_{n>&d}=0, &d≦&qa−&b (223)
R_{n≧&a}=S_{&a}, C_{n≧&q}=C_{n≧&q}, D_{n≧&d}=D_{&d}, &d≦&qa−&b (224)

$$\begin{matrix}\begin{matrix}{R}_{n \geq 1} = {R}_{0} + {r}_{1} + {r}_{2} + … + {r}_{n} \\ = {R}_{0} + {r}_{1}^{P} + {r}_{2}^{P} + … + {r}_{n}^{P} + {( f {c}^{F} )}_{1} + {( f {c}^{F} )}_{2} + … + {( f {c}^{F} )}_{n}\end{matrix} & \end{matrix} \qquad {( 131 )}^{′}$$

Eₙ≡S_{&a}−R₀−r^{P}₁−r^{P}₂− . . . −r^{P}ₙ (132)′
Fₙ≡f₁+f₂+ . . . +fₙ (133)

Thus the simultaneous linear equation to be solved (132)(133) is the following
Fₙc^{F}₀+Fₙ₋₁c^{F}₁+ . . . +F_{n-&q}c^{F}_{&q}=Eₙ, nε[&a, &qa], &qa=&q+&a (134)

Formula (134) is solved using the following matrix.
F_{i,j}≡F_{&a+i-j}; c=(c^{F}₀, . . . , c^{F}_{&q})^{T}; E=(E_{&a}, E_{&a+1}, . . . , E_{&qa})^{T};^{T}: transpose (135)
c=F⁻¹E (136)
c^{C}₀=k_{CRD}c^{F}₀, C₀=C₋₁+c^{C}₀, if (C₀<C^{MIN}){C₀=C^{MIN}} else if (C₀>C^{MAX}){C₀=C^{MAX}} (153)′

We expatiate on Tuning based on significant digits.

When we use NACS, we must determine the control period and the degree of COF. The degrees of COF can be estimated by the corresponding differential equation. And “&a” or “&b” is increased by the degrees of filters such as various lag, dead time, statistics smoothing, and degree of continuity. If the degree “M” of the corresponding equations cannot be estimated, it is determined the positive value less than “6”. Then each of “&q”, “&a” and “&b” is M. If single pole representation (&q=1) is preferred, each of “&a” and “&b” is “2 M−1”. (degree systemization, FIG. 12). If “D” is not fed forward, &b is neglected. In the case that NACS is used instead of simple PID, it may be sufficient that “&q=1, &a=2” by experience. Values “&q”, “&a”, and “&b” are usually determined finally by response test.

When the operation is the first time, the system enters into test phase, and response test is carried out. (FIG. 9). In test phase, noise level “r^{ε}”, control period “T”, the degree of COF and COF are determined or measured. (FIG. 15) “r^{ε}” is measured first. The manipulated variable is kept the fixed safe value “C^{SAF}” at first. The value “C^{SAF}” is the value that the controlled machine works most safely. When “D” can be controlled, “D” is also kept constant safe value “D^{SAF}” Then “R” becomes nearly constant within noise level before long. The initial control period is set the minimum period “T^{MIN}”. “r^{ε}” is measured as root mean square sum of “rₙ” and “r^{δ”. “r}^{δ}” is the digital error of measurement machine. Even if all measured values “rₙ” are zero, measured values have error of “r^{δ}”, therefore “r^{ε}” is corrected by “r^{δ}”. This measurement is carried out the fixed times “N^{MAX}”. However this value “r^{ε}” is not amplified by control gain. The value becomes from three times to ten times by experience. Therefore “r^{ε}” is multiplied by “k^{AMP}”, which is set about ten. Of course, “k^{AMP}” can be altered matching the case.
k^{AMP}≈10 (270)
N=N^{MAX}, r^{ε}=k^{AMP}·√{Σₙ₌₁^{N}(rₙ²+(r^{δ})²)}/N, p^{NS}=1/N (271)

It is undesirable that settling time is in excessively near future. And the control gain is inversely proportional to control period in many cases, as mentioned above. (252, 259)

We consider the start terms of “a” and “b” which are obtained by conversion formula.
a=(1−q)f, b=(1−q)g; a_{@a}=f_{@a}, b_{@b}=g_{@b} (272)

Impulse response function “f “or “g” is integral of R(t) during “T”.
R(t)=∫₀^{t}f(x)1(x)δ(t−x)dx=f(t), δ(x): delta function (093)

Therefore COF and REF become small when “T” is short. And these become rapidly very small when “T” is shorter than rising part of the response functions such as lag or dead time. (12 of FIG. 6) Controlled function “q” represents the damping rate of impulse response functions. The control precision depends on the precision (significant digits) of “f” or “a”. Thus COF becomes difficult to be identified in the fixed precision when “T” is excessively short. These facts suggest that there is a proper value for the control period. And if man use the control period shorter than the proper value man cannot get any good result.

While controlled system is a machine, it has limit. “R” and “C” have maximal values” R^{MAX}, C^{MAX}” and minimal values “R^{MIN}” and “C^{MIN}”. “R” and “D” are measured with noise level “r^{ε}” and “d^{ε”. “r}^{ε” and “d}^{ε}” include digital errors “r^{δ}” and “d^{δ}”. “C” is manipulated with error “cε”. If man want to get good control parameter, he must judge by threshold “r^{TH}”, “c^{TH}”, and “d^{TH}”. The parameter “k^{AC}” is the inverse number of the precision. Namely, when “R” is expected to be settled in the settling time within the precision 1% of the initial deviation, then “k^{AC}” is “100”. And if 0.1% is expected, “k^{AC}” is “1000”. The result of calculation using data of accuracy “k^{AC}” do not have accuracy exceed “k^{AC}”. Therefore it is desirable that data for tuning must have better accuracy than “k^{AC}”. (Statistical treatment can improve a little.)
Tuning condition: |rₙ|≧r^{TH}≡k^{AC}r^{ε}, |cₙ|≧c^{TH}≡k^{AC}c^{ε}, |dₙ|≧d^{TH}≡k^{AC}d^{ε}, (273)

The control period, therefore, must be determined so that COF can be identified with the preliminary fixed significant digits. Good COF makes the system stable and precise. And good COV, which can be calculated only using good COF, reduces noise because needless reactions aren't caused. It must be paid attention that the precision of digital data can be never improved by statistical treatment when noise is small compared with “r^{ε}”. Even if man use billions of such data that are truncated under yard, man cannot get mean value of man's height with the precision of inch. Therefore the condition “k^{AC}·r^{ε}” can be reduced by statistic only when noise is sufficiently large. However, When “k^{AC}·r^{ε}” is greater than full scale of “R”, it is impossible for |rₙ| to exceed it. And it is an abnormal control that “S” is frequently changed from the minimum value to the maximum value or its reverse except response test. The limit value of “k^{AC}·r^{ε}” is usually determined about 10% of full scale considering automatic tuning.
k^{LIM}≈0.1
k^{RES}=k^{AC}·r^{ε},s^{HL}≡k^{LIM}·(R^{MAX}−R^{MIN}), k^{RES}>s^{HL}→k^{RES}=s^{HL} (274)

Thus control period is determined so that the response namely “|rₙ|” becomes greater than “k^{RES}” in “T”. When dead time is considered, we recommend the following art. Control period is used as a timer. Control period is set minimum value “T^{MIN}” at first and “C” is kept response test value “C^{RES}”. If “R₀” changes “|R₀−R₋₂ₙ≧2·k^{AC}·r^{ε” after “}2·n·T^{MIN}”, control period, then “T” is determined “n·T^{MIN}”.
T=T^{MIN}, |R₀−R₋₂ₙ|≧2·k^{AC}·r^{ε}→set T=n·T^{MIN} (275)

“R” rises in the first or the second control period. When initial state can be considered, data are substituted.
R₋₃←R₋₃ₙ, R₋₂←R₋₂ₙ, R₋₁←R₋ₙ, R₀←R₀, r₋₂←R₋₂−R₋₃, r₋₁←R₋₁−R₋₂, r₀←R₀−R₋₁,
C₋₃=C^{SAF}, C₋₂=C₋₁=C₀=C^{RES}, c₋₂←C₋₂−C₋₃, c₋₁←C₋₁−C₋₂, c₀←C₀−C₋₁,
D₋₃=D₋₂=B₋₁=D₀=D^{SAF}, d₋₂=d₋₁=d₀=0 (276)

And if measurement is continued, impulse response function “fₙ” is given. (FIG. 15). “#f” is the period/order when “fₙ” is maximal, and is called peak order or peak period. If “&a<#f” then “&a” is let “#f” or “T” is changed. (FIG. 33). When “T” is changed, “T” is multiplied by “k”. Factor “k” is let more than “#f/&a”. (In FIG. 15, peak order is M, and peak value is f^{MAX}). This method is called optimization of period. The control period determined by this method becomes some time more than ten times of the period of PID. It reduces noisiness and gives room for man machine interface. If “R” does not change sufficiently within the fixed periods, then it is considered that the system is wrong. Connection is probably cut. Then safety program is let run. The alarm is output and the system is stopped for example.

When FF disturbance can keep constant, “q” and “a” are identified. After this identification response test of FF disturbance is carried out, and “b” is identified.

When “C” is manipulated “C^{SAF}”, data to identify “q” may not be taken. When “D” is not controllable, response test is repeated till tuning matrix for “q”, “a” and “b” become regular. After identification, if some of “q&q”, “a&a”, and “b&b” are negligible, they are omitted and their degree are decreased. COF is identified by the regression method and other parameters (for example, MAF) derived from COF are calculated.

Then system enters into normal phase.

If control is short of initial data, we wait. Waiting count “N^{CNT}” is set and count down at each period end.
N^{CNT}←&q+&a (277)

COF can vary/change during the operation. The quantity of ink decreases in printer control system for example. Therefore the identification during the operation namely automatic tuning is necessary if precise control is expected.

When “S” is changed, “R” is settled in “&a” periods. “C” becomes constant “&q” periods after. The data under control have only information “a” to be identified. When “D” is changed, only such data are given that only information “b” to be identified. Only when control is limited, “q” can be identified. During response test, the system is not controlled. (Test phase). When COF is not good, the system is not good controlled. (Oscillation event: FIG. 37). When “C” is calculated over maximal value or below minimal value, control is limited. (Saturation event: 36, 38). If a lump of “q”, “a”, and “b” is being identified using large tuning matrix, “q” or “b”, for which information is seldom given, may be broken by noise. It is better “q”, “a”, and “b” are identified separately except response test.

When the condition “|d_{n>-&b, n<0}|≧d^{TH}” is satisfied (FF event), “b” is tuned.
N_{b}=N_{b}+1, if N^{MAX}<N_{b}then N_{b}=N^{MAX}
p^{ID}≡1/N_{b,} x=(d₋₁, . . . , d_{-&b}); y=(r−qr−ac)₀, b=(b₋₁, . . . , b_{-&b}),
M_{b}←M_{b}+p^{ID}(x^{T}x−M_{b}), Y_{b}←Y_{b}+p^{ID}(yx^{T}−Y_{b}),
b=M_{b}⁻¹Y_{b}; (278)

Else when the condition “|c_{n>-&a, n<0}|≧c^{TH}” is satisfied (Command event), “a” is tuned.
Nₐ=Nₐ+1, if N^{MAX}<Nₐ then Nₐ=N^{MAX}
p^{ID}≡1/Nₐ, x=(c₋₁, . . . , c_{-&a}); y=(r−qr−bd)₀, q=(a₋₁, . . . , a_{-&a}),
Mₐ←Mₐ+p^{ID}(x^{T}x−Mₐ), Yₐ←Yₐ+p^{ID}(yx^{T}−Yₐ),
a=Mₐ⁻¹Yₐ; (278)

Else when the condition “|r_{n>-&q, n<0|}≧r^{TH},” is satisfied (Saturation event), “r” is tuned.
N_{q}=N_{q}+1, if N^{MAX}<N_{q} then N_{q}=N^{MAX}
p^{ID}≡1/N_{q,} x=(r₋₁, . . . , r_{-&q}); y=(r−ac−bd)₀, q=(q₋₁, . . . , q_{-&q})
M_{q}←M_{q}+p^{ID}(x^{T}x−M_{q}), Y_{q}←Y_{q}+p^{ID}(yx^{T}−Y_{q}),
q=M_{q}⁻¹Y_{q}; (279)

There are disturbances that are not fed forward i.e. not measurable disturbances. They sometimes cause the system damage, so that COF may be broken in tuning. (destroyer event).

When such disturbances happen, absolute value of the estimation error “h₀” becomes very large.

$$\begin{matrix}{h}_{0} ≡ {r}_{0} - {( qr + ac + bd )}_{0} \\ = {r}_{0} - {q}_{1} {r}_{- 1} - … - {q}_{\& q} {r}_{- \& q} - {a}_{1} {c}_{- 1} - … - \\ {a}_{\& a} {c}_{- \& a} - {b}_{1} {d}_{- 1} - … - {b}_{\& b} {d}_{- \& b}\end{matrix} \qquad ( 226 )$$

Small disturbances cause white noise. Noise height seldom exceeds three times of standard deviation of noise “3σ” and fast never exceeds five times of standard deviation “5σ”. We estimate “σ” by noise level “r^{ε”.}
h₀≧h^{TH}, h^{TH}≡k^{ε}·r^{ε}, k^{ε}≈5˜10→destroyer event (227)

As soon as destroyer event is detected, tuning stops.

When control program ends, the control system i.e. machine stops. After an interval, control restarts and machine begins work. Fast phase starts. Machine may be repaired or parts may be exchanged during the interval till control restarts. When such parts is exchanged that effect COF largely, re-tuning is usually necessary. When motor line is connected reverse motor rotates reverse direction, and re-repair is usually necessary. But re-repair becomes unnecessary by re-tuning in most case. Fast phase is the special phase that the control system is diagnosed and necessary re-tuning is made. Of course, no abnormality is found, control is continued using COF and tuning set of the last control operation. When fast phase starts, a spare tuning set “(M^{S}, Y^{S}, N^{S})” is prepared. It is desirable that spare tuning set is separated. Then only spare tuning set for “a” is usually prepared. By “N^{a}=0” matrix “M^{a}” and vector “Y^{a}” are cleared.
M^{S}=M^{a}, Y^{S}=Y^{a}, N^{S}=N^{a}; N^{a}=0 (228)

“C” is set “C^{SAF}” during “&a+1” control periods i.e. initial waiting cycles. After initial waiting cycles, settling control for the command and auto-tuning start. Data for noise level “r^{ε}” may be sampled, but they is not used to tune “r^{ε}”. It may be used for alarm or information. When destroyer event don't happen till “&a+&q” periods after “S” change, old tuning set substitutes spare set and normal phase starts. (M^{a}=M^{S}, Y^{a}=Y^{S}, N^{a}=N^{S}).

In fast phase, oscillation may occur by noise or command change (oscillation event). “R” may be driven reverse and “C” is fixed in “C^{MAX}” or “C^{MIN}” (saturation event). When oscillation event or saturation event happen, destroyer event also happens. Destroyer event in normal phase is considered that not fed forward disturbance occurs, and tuning stops. But destroyer event in fast phase is considered that COF becomes wrong by repair, and tuning continues. When saturation event happens, it is not clear whether line is connected reverse or not. Therefore, special response test is tried. Reverse value is out put one period, and “C^{SAF}” is continuously out put till tuning data are completed. (When C₋₁=C^{MAX} then C₀=C^{MIN}, and when C₋₁=C_{MIN} then C₀=C^{MAX}.). When destroyer event happens, control restores as soon as tuning data are completed and COF is newly tuned. After destroyer event, we wait destroyer event stops, and the system runs into normal phase.

Man who sets excessively short control period appeals that the interval from the command change to the settled time is important. Settling time is almost minimal in NACS. The delay from the command change to the beginning of the next control period can be cut by the following art called command breaking. If the command is changed at 100·t % of the period then COV is exchanged with time weighted average values as the following and differences are calculated using the modified new values.

And new period is let start (FIG. 10) at once on the road of the period.
R←tΛR+(1−t)R, C←t←C+(1−t)C, D←tΛD+(1−t)D
r=ΔR, c=ΔC, d=ΔD (229)

Thus NACS is applicable to the complex system. The system is very stable even if strong disturbance is given. And the system parameter can be constituted automatically. Namely the control period is determined by the significant digits of COF, degree of COF is determined by the degree systemization, and COF is identified based on control precision. And the manipulated variable is calculated solving COFRE under the condition of FT determining. The solution formula of manipulated variable is a linear form of COV.

### BRIEF EXPLANATION OF THE DRAWINGS

Explanation of common symbols:

| | |
|---|---|
| R: controlled variable | C: manipulated variable |
| D: measurable disturbance | S: command |
| r: difference of R | c: difference of C |
| d: difference of D | s: difference of S |
| q: controlled function | a: manipulated function |
| b: FF function | t: time |
| T: the control period | /*“ . . . ”*/: comment |
| @: start order | &: end order or degree |
| &qa = &q + &a: settling time | &qab = &q + &a + &b: determination |
| &d ≦ &q + &a − &b: end | time |
| order to be used | ^{U}: unknown part of data |
| ^{K}: known part of data | ^{D}: settled part of command |
| ^{O}: old part not used | ^{′}: sequence of MAF |
| ^{T}: transpose | ^{MIN}: minimal value |
| ^{MAX}: maximal value | ^{TH}: threshold |
| ^{SAF}: safe value | ^{ε}: error level |
| ^{HL}: range | ^{T}: transposed matrix |
| ^{δ}: digital error | ⁻¹: inverse matrix |
| ⁻: approximate inverse matrix | |

FIG. 1 is the master table to calculate out the manipulated variable in the case that COFRE is represented by “r=qr+ac+bd”. The matrix form is “mx=e=k(S_{&a}−R₀)−qr^{K}−ac^{K}−bd^{K}”. The last row represents “r₁+r₂+ . . . +r_{&a}=S_{&a}−R₀”. Matrixes mx, k(S_{&a}−R₀), qr^{K}, ac^{K}, bd^{K} are shown in FIGS. 18˜22. The unknown vector is x=“(c₀, c₁, . . . , c_{&q}, r₁, r₂, . . . , r_{&a})^{T}” in the left side. Each term in the right side except for the last row is “0·(S_{&a}−R₀)”, “qr^{K}”, “ac^{K}”, and “bd^{K}” except the last line. The super script ^{“K”} means known part of the data. Unknowns are got calculated inverse matrix m⁻¹. And the newest difference of the manipulated variable “c₀” is represented as MAFRE.

FIG. 2 is the master table to calculate out the manipulated variable in the case that COFRE is represented by “R=qR+aC+bD”. The matrix form is “MX=E=KS_{&a}−QR^{K}−AC^{K}−BD^{K}”. Matrixes MX, KS_{&a}, QR^{K}, AC^{K}, BD^{K} are shown in FIGS. 23˜27. The unknown vector is X=“(C₀, C₁, . . . , C_{&q}, R₁, R₂, . . . , R_{&a-1})^{T}” in the left side. Each term in the right side is “(1−q)S^{D}”, “qR^{K}”, “aC^{K}”, and “bD^{K}”. Unknowns are got calculated inverse matrix M⁻¹. And the newest manipulated variable “C₀” is represented as MAFRE.

FIG. 3 shows the derivation of equations in the previous applications and this application. This chart is for help to distinguish notation of the equations.

FIG. 4 shows the electric circuit for explanation of Minimal-Time Control and FT settling.

Explanation of Symbols:
1: Resister
2: Capacitor/Condenser
3: Voltage source
4: Switcher
C^{MAX}: maximal voltage
C^{CAL}: calculated voltage
S₁: target voltage

FIG. 5 shows voltage curves of FIG. 4; how the controlled variable is settled by FT settling in the both cases analogue control system and digital control system. “S” is the command, “R” is the controlled variable, “C” is the manipulated variable, and “T” is the control period.

Explanation of symbols:
5: Manipulated variable of analogue system
6: Manipulated variable of digital system
7: Controlled variable of analogue system
8: Controlled variable of digital system

FIG. 6 shows the types of impulse response functions, which can be applicable to Minimal-Time Control, OACS, and NACS. The system of all types of impulse response function can be controlled by NACS and settled in FT settling.

Explanation of symbols
9: Impulse response function that can be controlled by all of MTC, OACS and NACS. This curve is an exponential curve.
10: Impulse response function that can be controlled by OACS and NACS.
11: Impulse response function that can be controlled only by NACS.
12: Dead time.

FIG. 7 shows graph how the controlled variable deviates from the command when FF disturbance is changed step wise in the cases of not fed forward, not FT determining namely the previous art, and FT determining. By FT determining the deviation can be suppressed ideally. But not FT determining cannot suppress the deviation sufficiently.

Explanation of symbols
1: Controlled variable when the system is controlled by NACS of the previous art, namely under the condition of not FT determining when FF disturbance is changed stepwise.
2: Controlled variable when the system is controlled by the art of the invention, namely under the condition of FT determining when FF disturbance is changed stepwise.
3: Controlled variable when the system is controlled by NACS without feed forward of FF disturbance when FF disturbance is changed stepwise.

FIG. 8 shows graph how the controlled variable deviates from the command when the command is changed in the cases of not FT determining namely the previous art, and FT determining. By FT determining the deviation can be suppressed ideally. But not FT determining cannot suppress the deviation sufficiently.

Explanation of symbols
1: Controlled variable when the system is controlled by NACS of the previous art, namely under the condition of not FT determining when the command (S) is changed.
2: Controlled variable when the system is controlled by the art of the invention, namely under the condition of FT determining when the command (S) is changed.

FIG. 9 is the flow chart of the invention.

When the system is controlled first time, control parameters are determined in test phase (Phase=Test). And when the system is restarted control parameters are checked in fast phase. (Phase=Fast). In fast phase, changes in the interrupt of control are corrected. The manipulated variable is calculated solving propagator represented by COFRE under the condition of FT determining in fast phase and in normal phase. The solution is MAFRE.

FIG. 10 is the flow chart of the subroutine “Command break”.

In the subroutine the command is got and when the art of command breaking is allowed (F^{CB}=1) and new command is given (OS≠S_{&a}) then COV is exchanged with the time weighted average value and new period is let start (Set T=T) in the road of the control period. When command breaking is not allowed or new command is not given, the system is let wait for the end of the period (t>0.99) and COV is renewed for the new period. “t” is a timer that becomes 0 at the beginning of the period and 1 at the end of the period. “N^{CMD}=0” is the case that command break is not used. When command break is used, subroutine works as a timer.

FIG. 11 is the flow chart of subroutine “Estimate noise level”. Noise level “r^{ε}” is calculated root mean square of estimation error “r₀” considered digital error “r^{δ}” in test phase.

FIG. 12 is the flow chart of the subroutine “Degree systemization”.

If the degree of the corresponding differential equation is unknown it is supposed “5”. “N^{POLE}=1” means single pole representation. If single pole representation is adopted each degree of “&q”, “&a” and “&b” is momentary supposed “1”, “2N−1” and “2N−1” respectively. Else each of them is momentary supposed “N”. And each filter effect is added to them. The degree of unknown filter is supposed “1”.

FIG. 13 is the flow chart of the subroutine “Calculate event threshold”.

Threshold of tuning is determined based on significant digits of data.

FIG. 14 is the flow chart of the subroutine “Measure”.

Control variables “R, C, D, r, c, d” are renewed at the beginning of each period.

The newest measured “R₀” and the newest disturbance data “d_{-&d}” are given. The last manipulated variable “C₋₁” is confirmed. Set value “C₋₁” may not be exact. And their differences are calculated.

FIG. 15 is the flow chart of “Response test”.

Explanation of symbols
M: peak order,
rₙ: corresponding to fₙ
f^{MAX}: peak value

The rising time is detected at first, so that sample data has sufficient significant digits. And peak time is detected so that settling in excessively near future is avoided. And damping part of the impulse response function is reserved more than “&q/&a” times of before peak. Thus impulse response function is measured, control period, size of COF, and COF are determined.

FIG. 16 is the flow chart of subroutine “Calculate q, a, b”. Identify q, a, b using response test data. Separate type tuning sets are made using tuned COF by response test.

FIG. 17 is the flow chart of tuning in fast phase and in normal phase. COF is tuned only when data has sufficient significant digits.

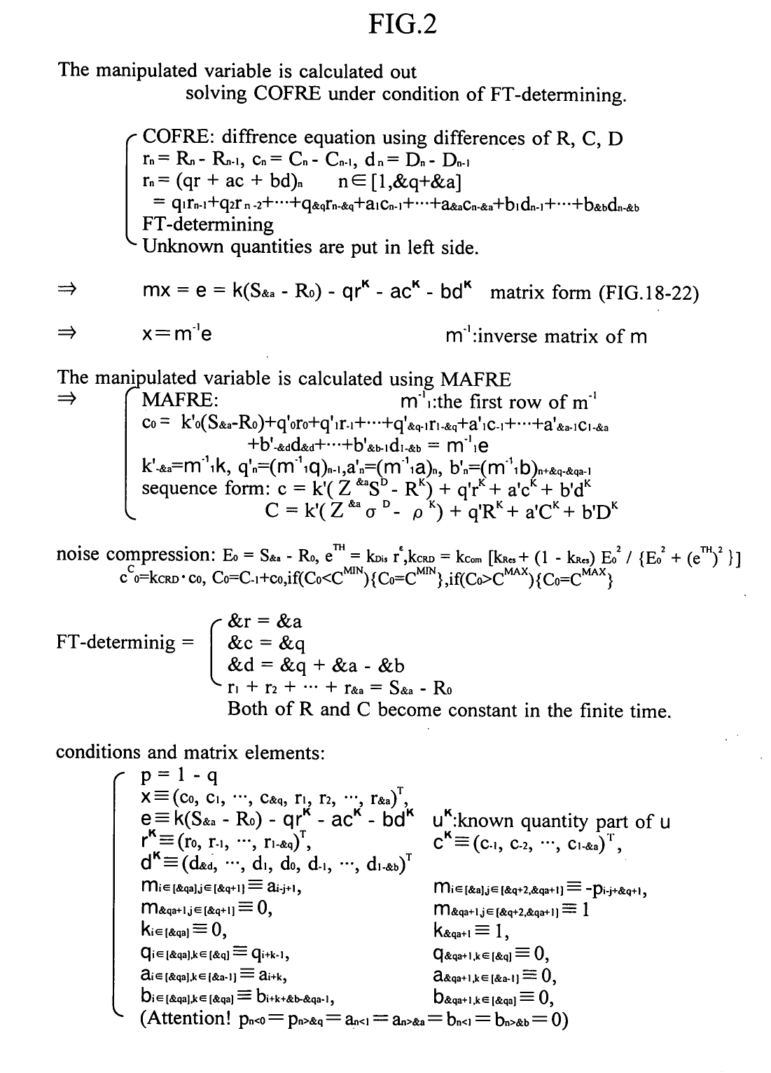

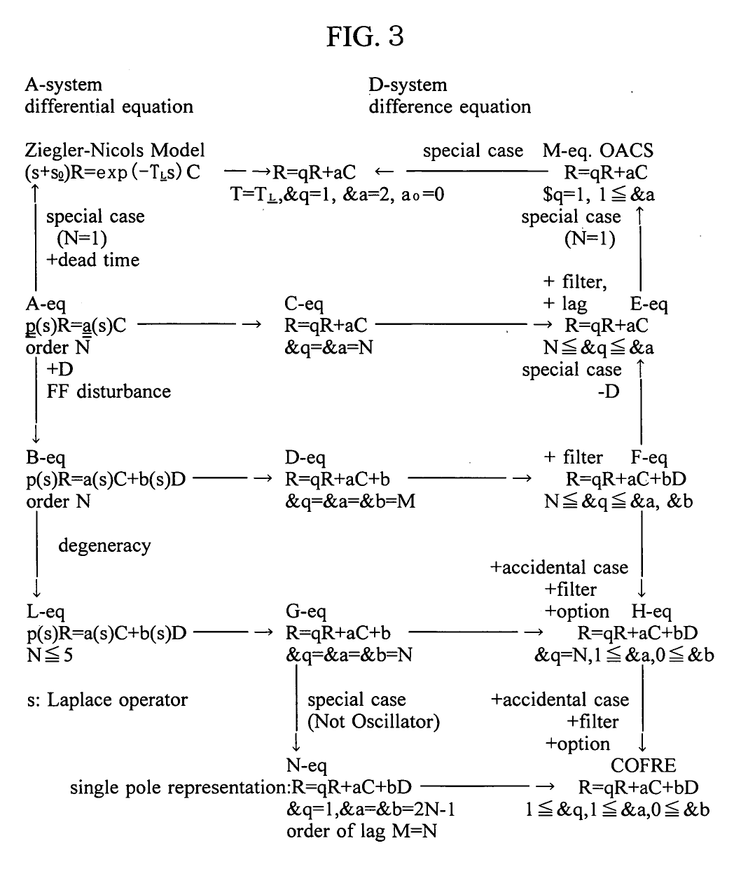

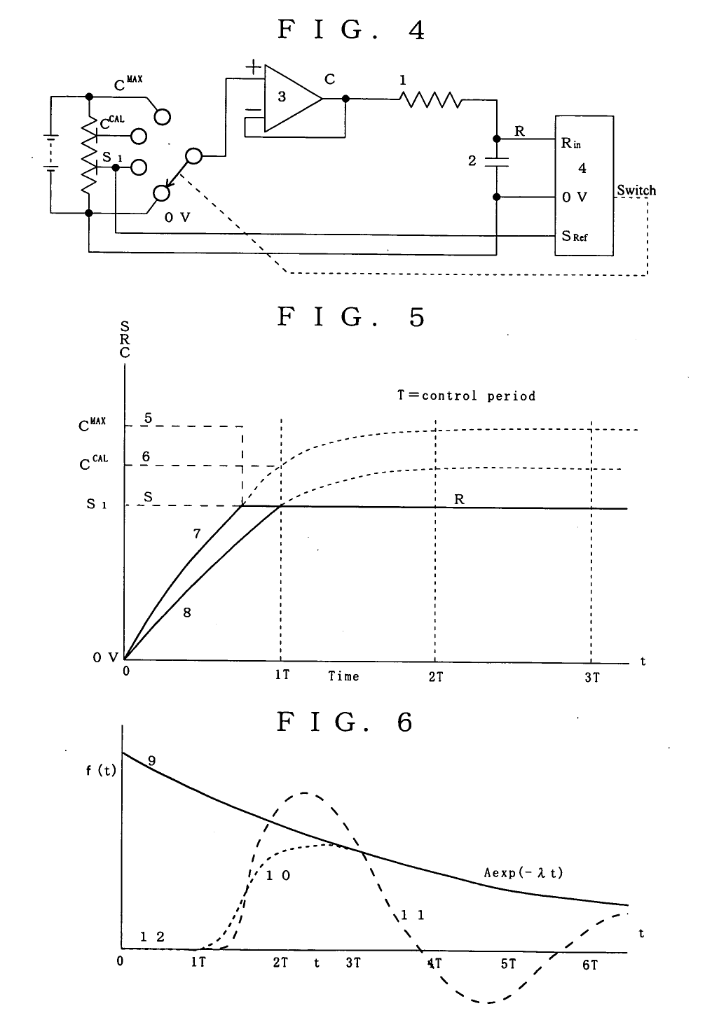

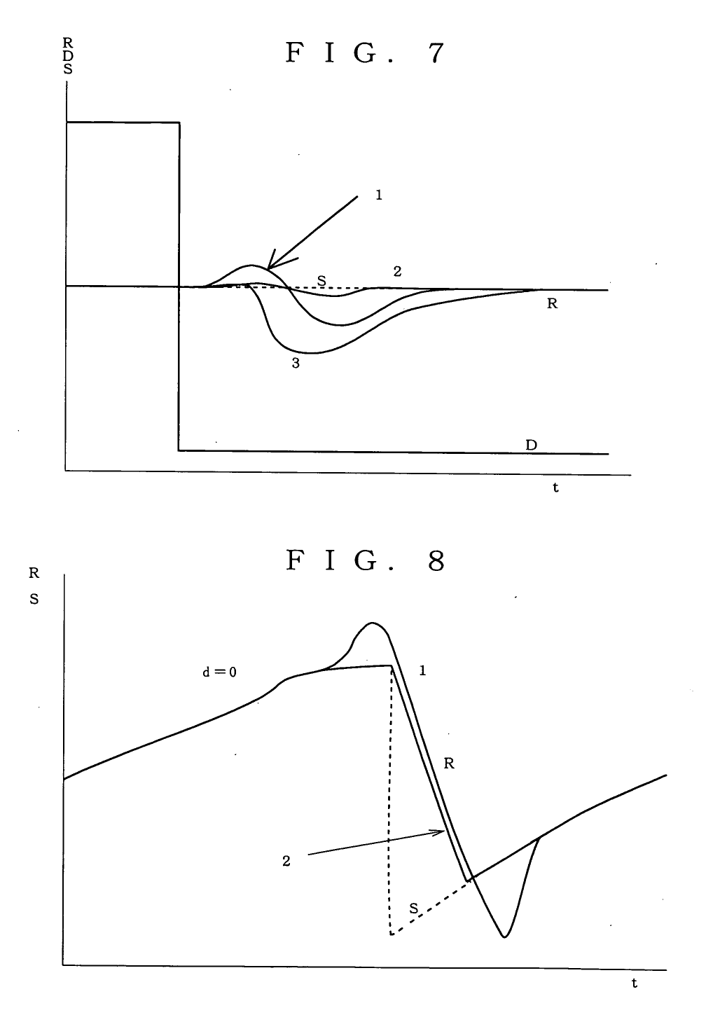

FIG. 18 is the matrix form of the part “mx” of FIG. 2. Unknown vector is “x”. Inverse matrix of “m” is calculated.

FIG. 19 is the matrix form of the part “k(S_{&a}−R₀)” of FIG. 2. “k′” is calculated as “m⁻¹₁k”. “S_{&a}−R₀” is the control error, and “k′ is corresponding to control gain.

FIG. 20 is the matrix form of the part “qr^{K}” of FIG. 2. “q′” is calculated as “m⁻¹₁q”. “r^{K}” is measured part of controlled variables. “q′ is a MAF for “r^{K}”.

FIG. 21 is the matrix form of the part “a c^{K}” of FIG. 2. “a′” is calculated as “m⁻¹₁a”. “c^{K}” is controlled variable that is already out put. “a” is a MAF for “c^{K}”.

FIG. 22 is the matrix form of the part “bd^{K}” of FIG. 2. “b′” is calculated as “m^{31 1}₁b”. “d^{K}” is the known measurable disturbance. “b′ is a MAF for “d^{K}”.

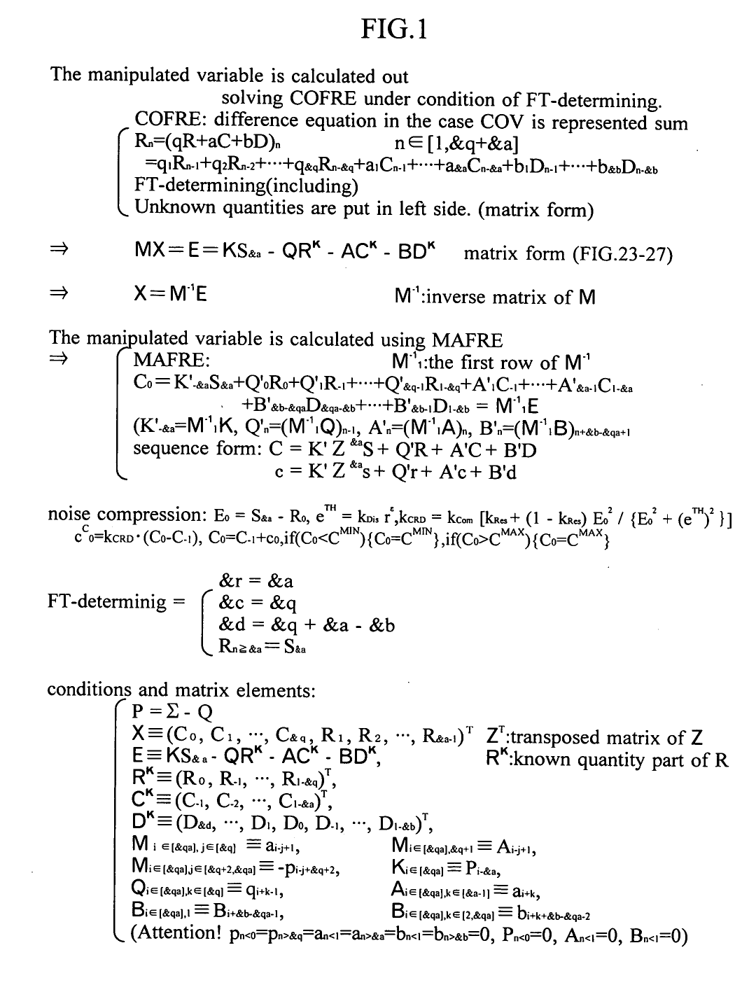

FIG. 23 is the matrix form of the part “MX” of FIG. 1. Unknown vector is “X”. Inverse matrix of “M” is calculated.

FIG. 24 is the matrix form of the part “KS_{&a}” of FIG. 1. “K′” is calculated as “M⁻¹₁K”. “S_{&a}” is the command, and “K′ is corresponding to control gain.

FIG. 25 is the matrix form of the part “QR^{K}” of FIG. 1. “Q′” is calculated as “M⁻¹₁Q”. “R^{K}” is measured part of controlled variables. “Q′ is a MAF for “R^{K}”.

FIG. 26 is the matrix form of the part “AC^{K}” of FIG. 1. “A′” is calculated as “M⁻¹₁A”. “C^{K}” is controlled variable that is already out put. “A′” is a MAF for “C^{K}”.

FIG. 27 is the matrix form of the part “BD^{K}” of FIG. 2. “B′” is calculated as “M⁻¹₁B”. “B^{K}” is the known measurable disturbance. “B′ is a MAF for “D^{K}”.

FIG. 28 is the flow chart of fast phase and normal phase.

FIG. 29 is the flow chart of the subroutine “Check event” Destroyer event is commonly checked in fast phase and normal phase. If saturation event happens in fast phase, impulse response test is tried.

FIG. 30 is the flow chart of the subroutine “MAFRE”. The manipulated variable is calculated solving future part of COFRE under the condition of FT determining. One of three calculation methods is selectable.

FIG. 31 is the table of the summary of sequence. Rules and definitions of sequence are listed.

FIG. 32 is the table of the calculation result. It shows that propagator with lag or dead time can be represented by COFRE of low degree.

FIG. 33 is the graph to show excessively near future. “#f” is the peak order. “f” is the impulse response function.

FIG. 34 is the flow chart of subroutine “regression of q, a, b”. Data are given endlessly. And a lump of “q, a, and b” is tuned. The case that “q”, “a” and “b” are identified separate is shown in FIG. 17.

FIG. 35 is the table with list that shows comparison between PID and NACS.

FIG. 36 is the graph that shows events.

Explanation of symbols
\textcircled{1}: Command event, i.e. command is largely changed.
\hat{2}: Saturated event in normal phase, i.e. the manipulated variable is fixed limit value.
\textcircled{3}: FF event, i.e. FF disturbance is largely changed.
\textcircled{6}: Destroyer event, i.e. estimation error becomes large.

FIG. 37 is the graph that shows oscillation event in fast phase.

Explanation of symbols
\textcircled{5}: Oscillation event, i.e. the control variable oscillates.
\textcircled{6}: Destroyer event, i.e. estimation error becomes large.

Oscillation stops after tuning.

FIG. 38 is the graph that shows saturation event in fast phase.

Explanation of symbols
\textcircled{4}: Saturated event in fast phase, i.e. the manipulated variable is fixed limit value.

\textcircled{6}: Destroyer event, i.e. estimation error becomes large.

The system is released from saturation event after impulse response test and tuning.

FIG. 39 is a block diagram of the invention. MAFRE is “c=k′e+q′r+a′c+b′d” Command S_{&}a and the newest controlled variable R₀ is got at the beginning of the period and the manipulated variable C₀ is calculate using such data as FF disturbance Dₙ (measured values and/or planned values), manipulated variable Cₙ (out put values), controlled variable Rₙ (measured values), and command S_{&}a (future value). Calculation formula (MAFRE) of C₀ is a linear equation of above-mentioned values. The formula is got solving future part of propagator (COFRE) under the condition of FT determining. COFRE is a linear equation of FF disturbance Dₙ (past values), manipulated variable Cₙ (out put values), and controlled variable Rₙ (measured values). The coefficient of COFRE is identified by regression method using such data that have sufficient significant digits (tuning diagnosis).

FIG. 40 is a block diagram of the invention. MAFRE is “C=K′S_{&a}+Q′R+A′C+B′D” Command S_{&}a and the newest controlled variable R₀ is got at the beginning of the period and the manipulated variable C₀ is calculate using such data as FF disturbance Dₙ (measured values and/or planned values), manipulated variable C, (out put values), controlled variable Rₙ (measured values), and command S_{&a} (future value). Calculation formula (MAFRE) of C₀ is a linear equation of above-mentioned values. The formula is got solving future part of propagator (COFRE) under the condition of FT determining. COFRE is a linear equation of FF disturbance Dₙ (past values), manipulated variable Cₙ (out put values), and controlled variable Rₙ (measured values). The coefficient of COFRE is identified by regression method using such data that have sufficient significant digits (tuning diagnosis).

### THE BEST WORKING MODE OF THE INVENTION

We have applied NACS for motor control, heater, chiller, position & speed control, and so on. The invention is applicable to from the simple system to the complex system. Therefore we describe the simple mode at first. When the invention is substituted for PID system “&q=1, &a=2” is sufficient in many cases. “C₀” is calculated by (J01) in this mode.
C₀=C₋₁+k′₀(S₁−R₀)+q′₀(R₀−R₋₁)+a′₁(C₋₁−C₋₂) (J01)

This MAFRE is very simple. However, the control period must be optimized because “R” rises up less than 4 bits within several periods of many PID systems. If the system has more than 12 bits AD-converter then the period is set so that “R” rises more than 8 bits within two periods in the response test that “C” is set “C^{MAX}”. COF is identified by the following using data of the response test.
x_{nε[}3]≡(Rₙ₋₁, Cₙ₋₁, Cₙ₋₂), X≡(x₁^{T}, x₂^{T}, x₃^{T})^{T},
Y≡(R₁, R₂, R₃)^{T}, COF≡(q₁, a₁, a₂)^{T}, COF=X⁻¹Y (J02)

MAF is calculated using COF as the following (C41).
k′₀=m⁻¹_{1,4}=1/(a₂+q₁a₁), A₂=a₁+a₂
q′₀=−q₁m⁻¹_{1,1}=−q₁(a₂+q₁A₂)/A₂(a₂+q₁a₁),
a′₁=−a₂m⁻¹_{1,1}=−a₂(a₂+q₁A₂)/A₂(a₂+q₁a₁) (252)

When COF is considered constant such as mass productions (JO 1) can use COF identified in the factory. This is the simplest mode. The system is stable because automatic tuning is not carried out. The settling time is two periods in this mode.

Therefore, control speed is very fast.

If the system is complex and the control precision is requested then the invention must be carried out adding necessary procedures of the invention or of the previous NACS. We describe the procedures.
1. The control period is determined by optimization of period so that COF can be identified above the fixed precision (significant digits).
2. The degree of COF is determined by degree systemization. Namely, when the corresponding differential equation is supposed the “&q”, “&a” and “&b” are supposed “N” the degree of the equation. If the equation cannot be considered the “&q”, “&a” and “&b” are supposed “5”. This value can be decreased or increased investigating the system. When single pole representation is preferred “&a” and “&b” is supposed “2M−1”. The degrees of effective filters are supposed next. If the supposition is difficult then the filters of degree “1” are supposed. “&a” is added by the degrees of the filters for “R” and “C” and “&b” is added by the degrees of the filters for “R” and “D”. When “q”, “a” and “b” is identified in response test negligible terms of “q”, “a” and “b” are omitted.
3. COF is identified in response test, in fast tuning and in normal tuning by the regression method that observation equation is COFRE.
4. COF is identified by tuning diagnosis in normal phase only when it is judged that COF is identified above the fixed precision (significant digits) and the destroyer event i.e. not-measurable disturbance, which is greater than noise level, doesn't happen. The estimation gap is watched and as soon as its abnormal deviation is observed, automatic tuning is stopped. Thus automatic tuning can be carried out without instability.
5. COF is identified by fast tuning when the system is restarted so that the system can adapt for the change during the interruption. The destroyer event is considered in fast phase that the system is changed and COF is wrong. The estimation gap is also watched in restart and only when its abnormal deviation is observed newly tuned data is substituted for old tuned data. Thus the system can rapidly adapt for repair and exchange of components during the interruption.
6. The manipulated variable is calculated out solving COFRE under the condition of FT determining. Man can use its solution formula namely MAFRE. Using MAFRE, man can combine the command and select MAFRE. Exchanging parameters of NACS, various subsystems can be exchanged. When the command concerns the relation of the sum and the difference between them, COF becomes common between them. If all COV of all subsystems can be observed in each subsystem then subsystems can be exchanged without waiting time to collect data for control.
7. When the shortest delay time from the command change to the settling is desired the command can be set by command breaking. New period is started at once in the road of the control period exchanging COV with the time weighted average value.
8. If the system is noisy, noise compression and/or error distribution can be used instead of filters so that the manipulated variable is amended before output.

### APPLICABILITY TO THE INDUSTRY

Industry cannot work without control technology today. The invention offers very precise and simple control technology. It is applicable to from the simple system to the very complex system. Feed forward, it is a dream for PID, can be naturally realized. The size of parameter is theoretically and easily determined. The control period can be optimized. The system can defend against not measurable disturbance and can rapidly adapt for repair and exchange of components when automatic tuning is carried out. NACS of the invention can be applicable to the variety of systems and the following can be said.
a) The settling time is minimal.
b) The manipulated variable can be easily calculated.
c) Noise is reduced.
d) The control period is long enough.
e) The system is very stable.
f) Feed forward of FF disturbance is easy.
g) Control parameters are tuned automatically.
h) The system itself can be automatically constituted. Namely the control period and the degree of COF can be determined automatically.
i) The theoretical background is steady.
j) Theory and procedures are easily understood.

The invention offers a new intelligent control system. The theoretical derivation of the system of the invention is indeed complicated and difficult, but the result is very clear and simple and easily understood. Man who has a patience to understand the system of the invention can easily use the invention. When man becomes familiar with the invention, he can get many information or ideas from COF, and can be charmed with causality clear propagator. When man has a trouble, propagator and solution are very helpful. It may not be understood without experience.

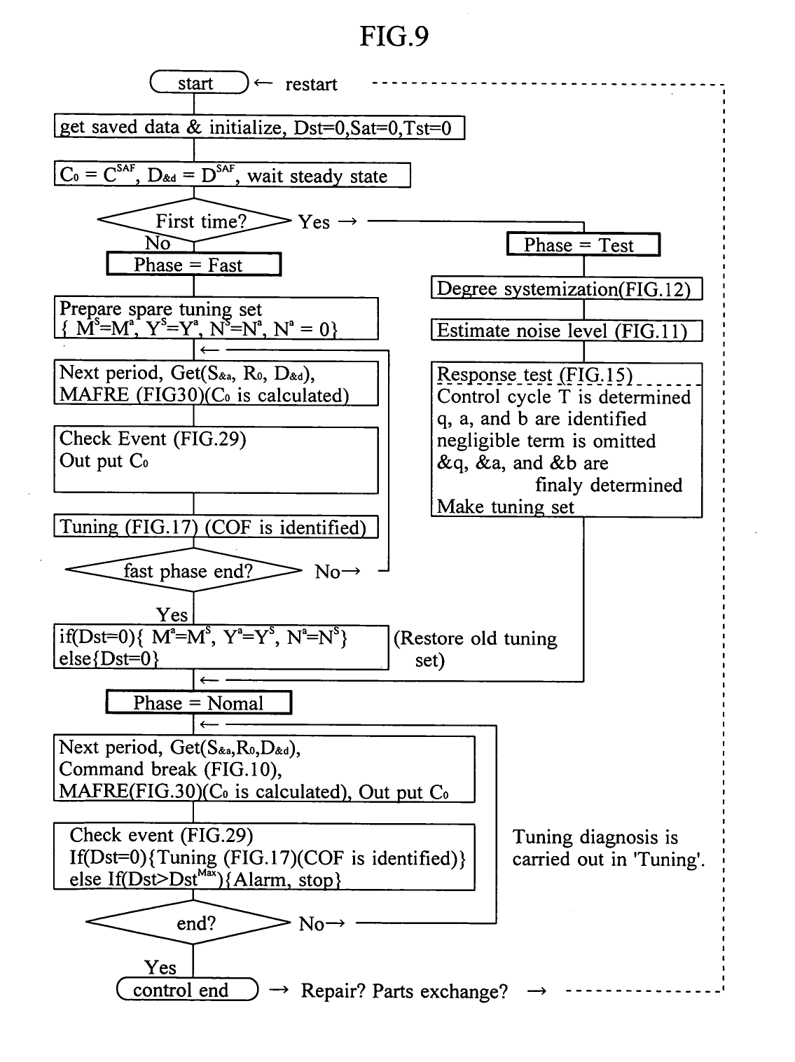

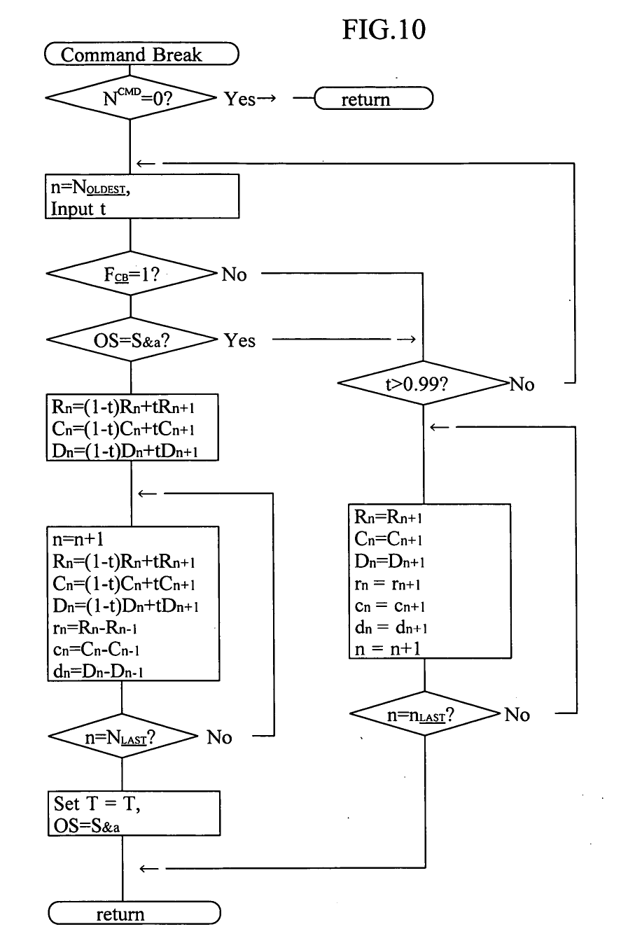

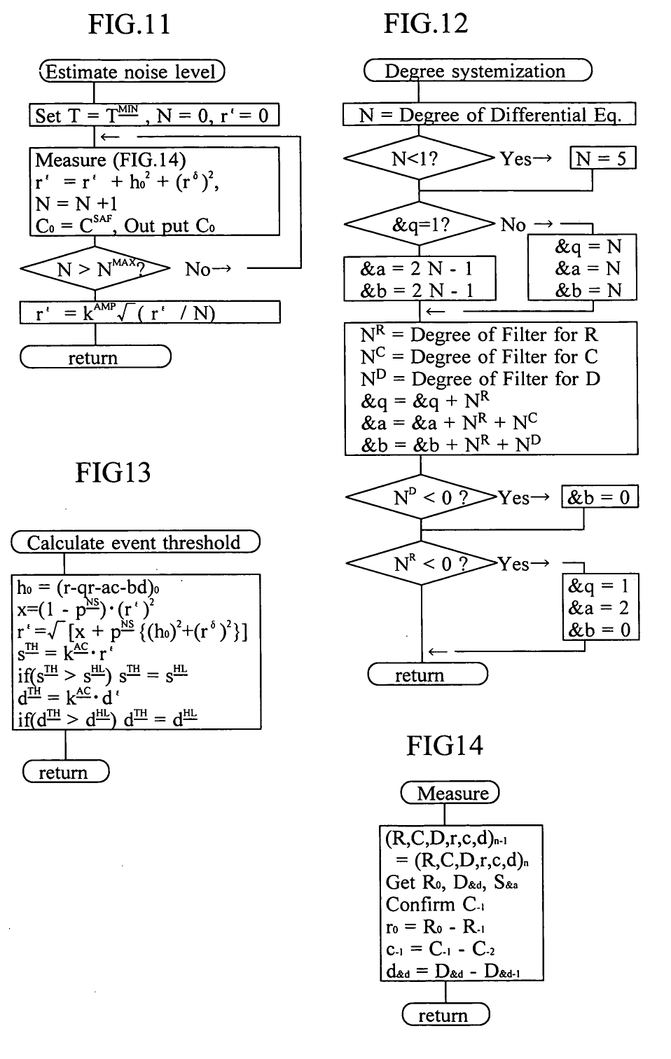

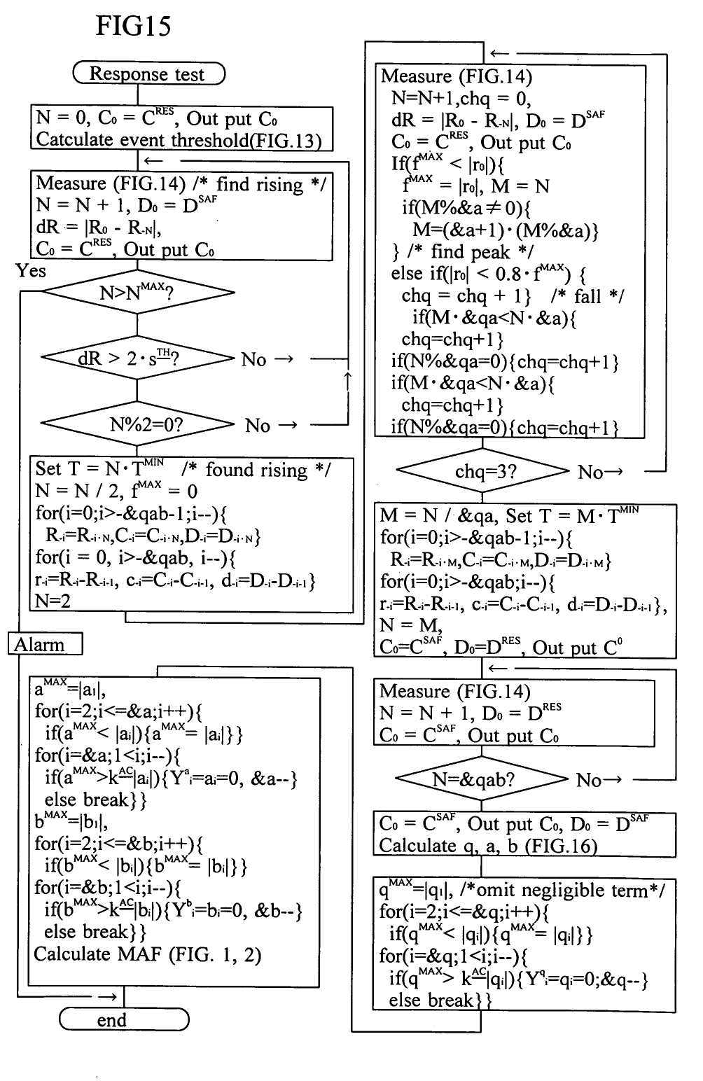

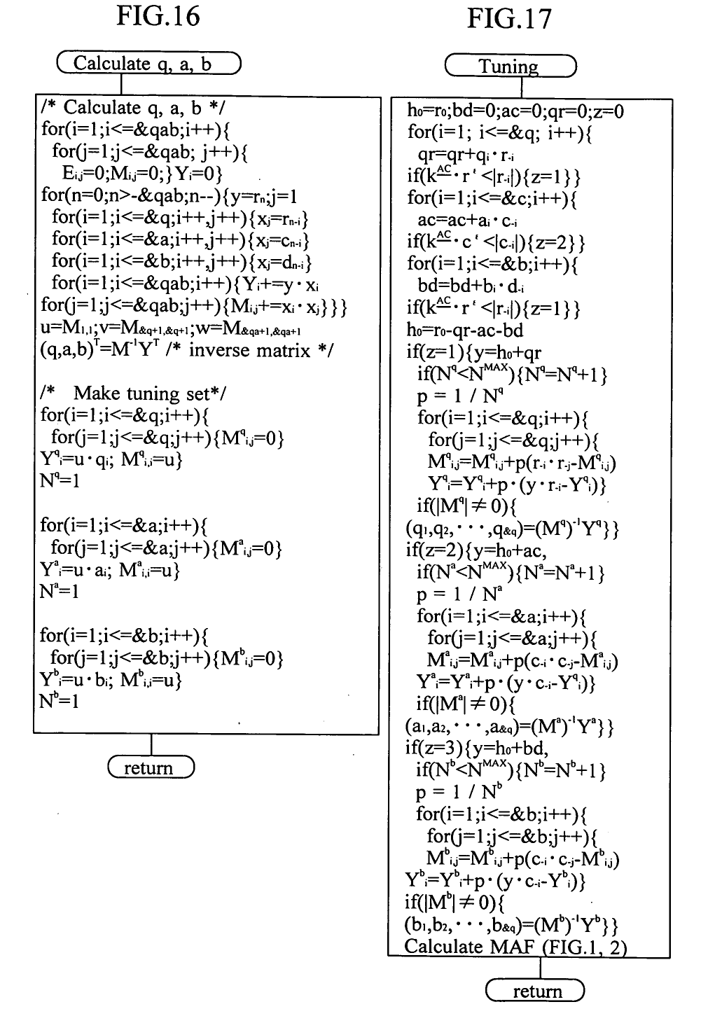

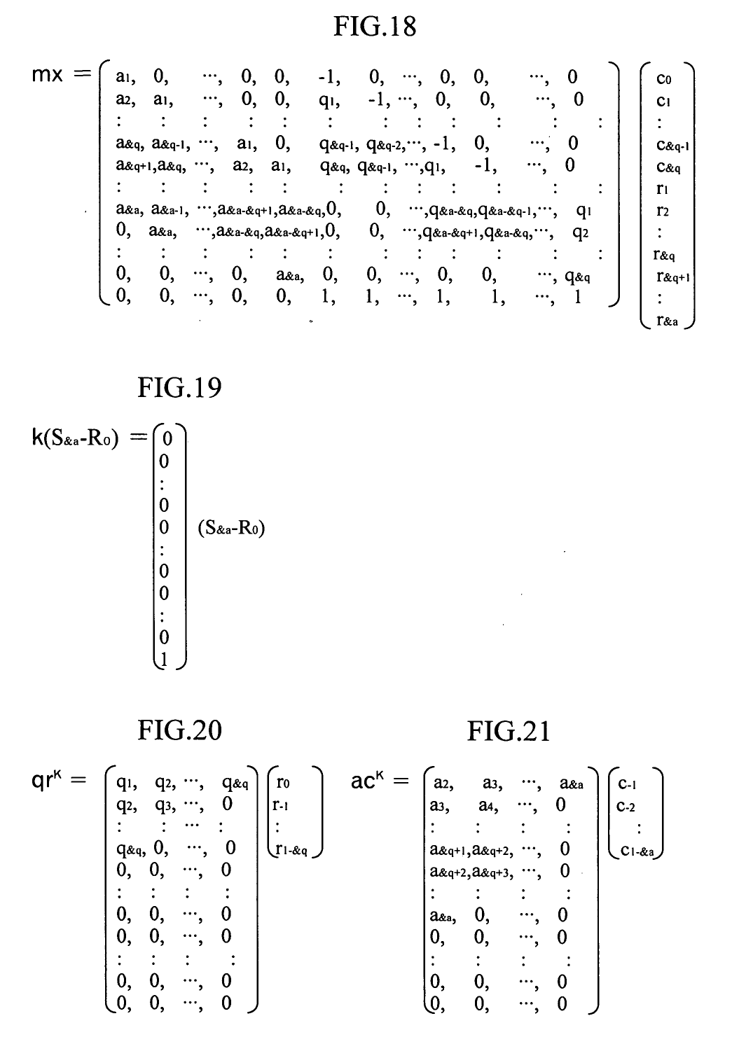

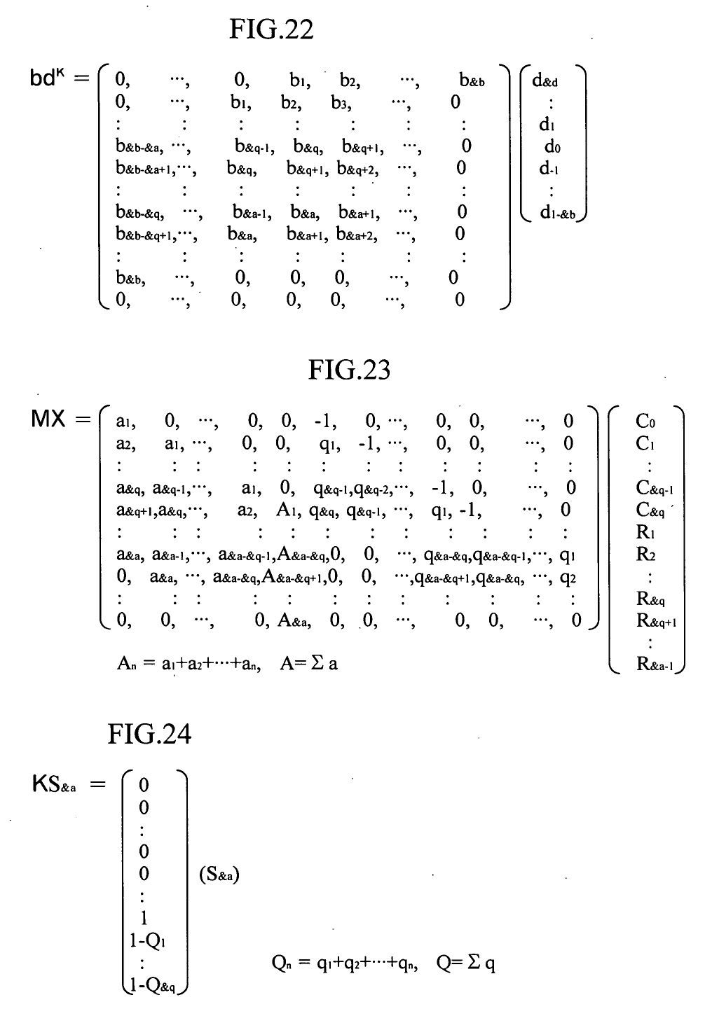

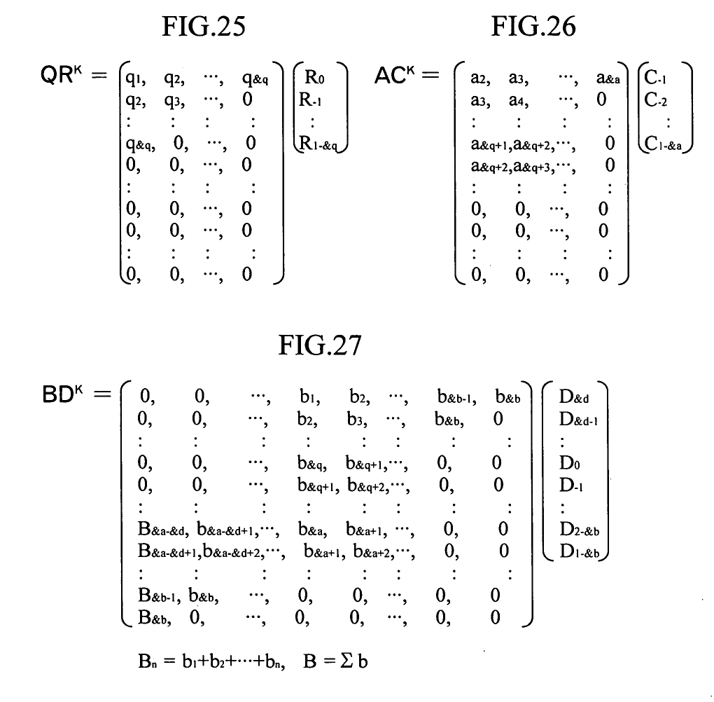

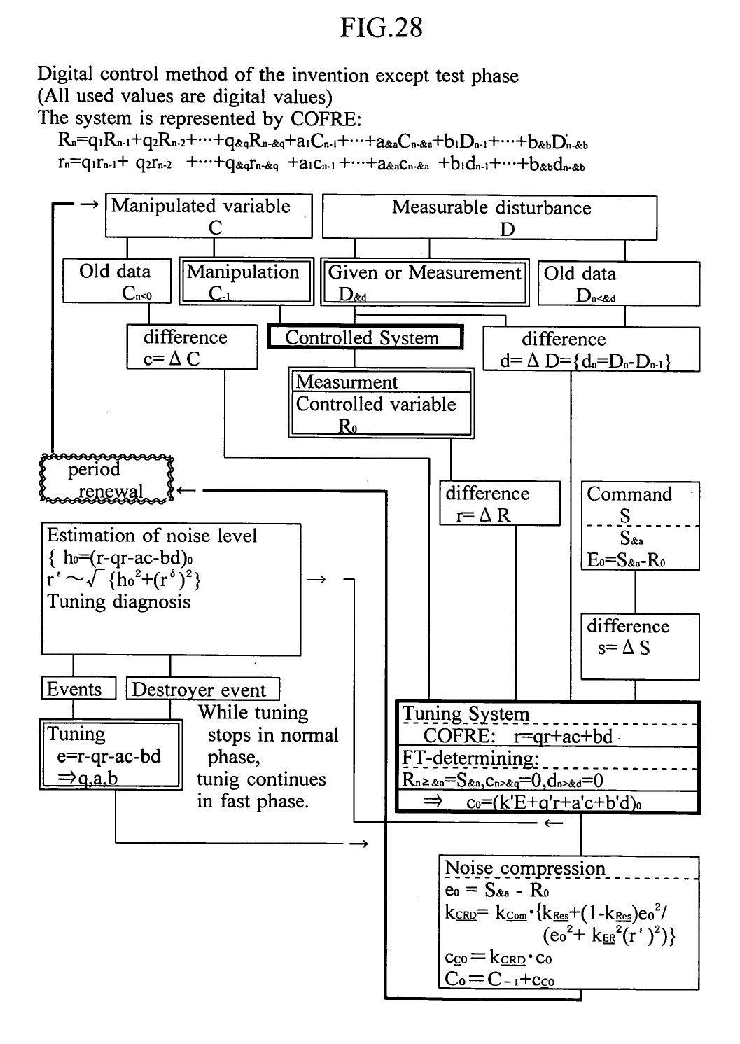

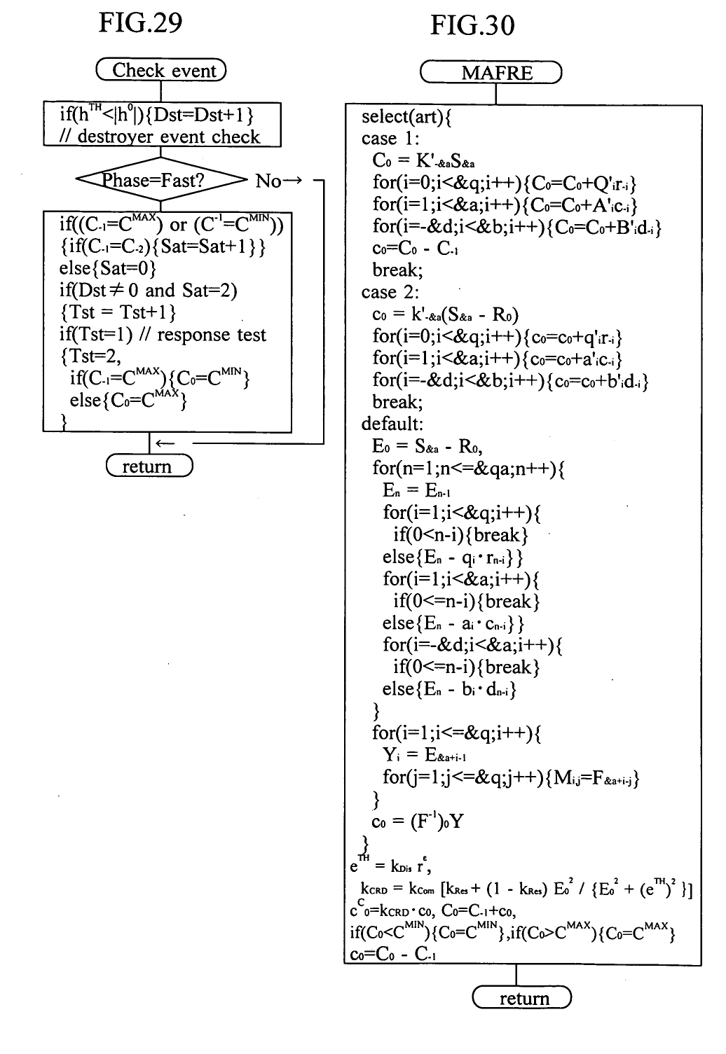

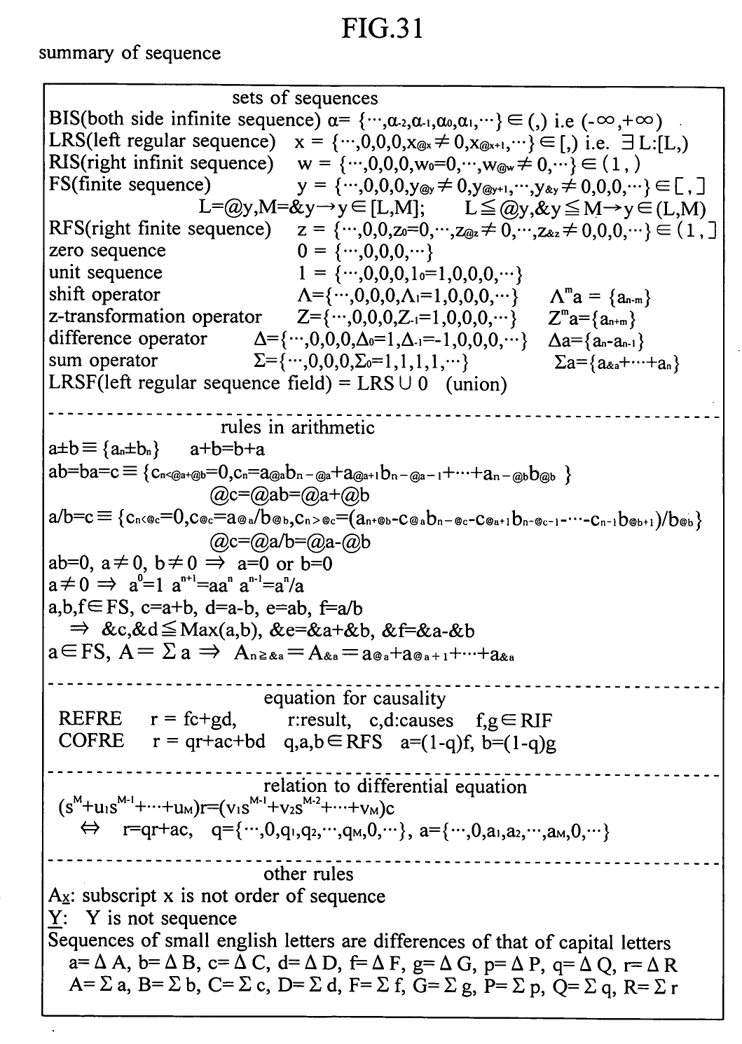

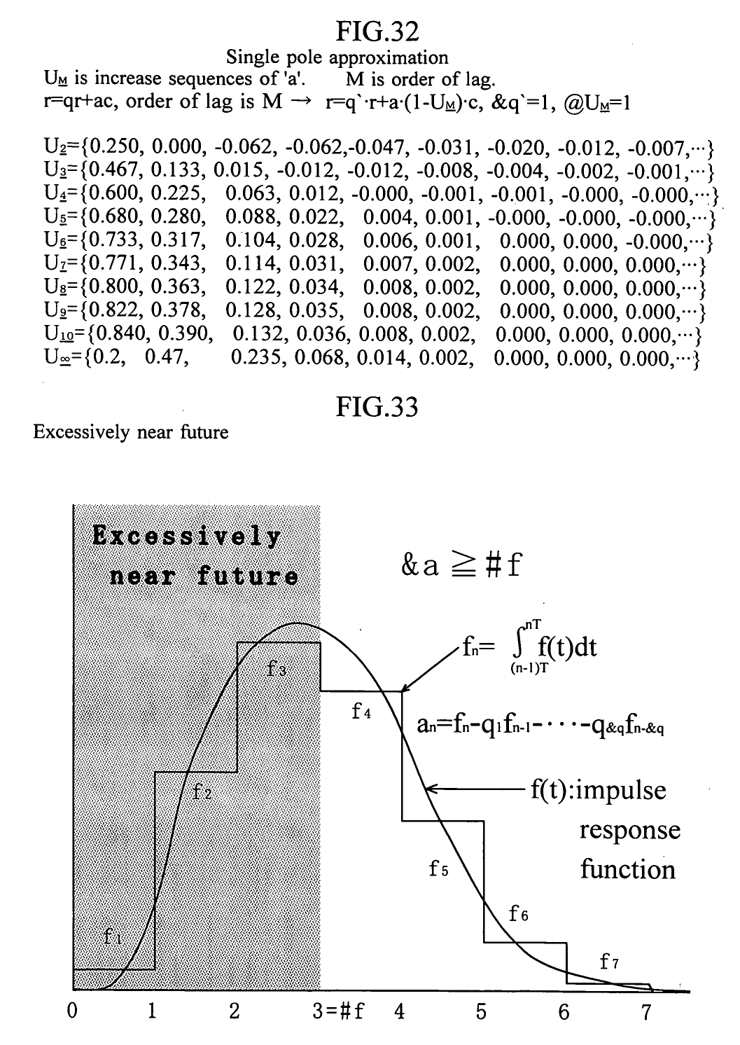

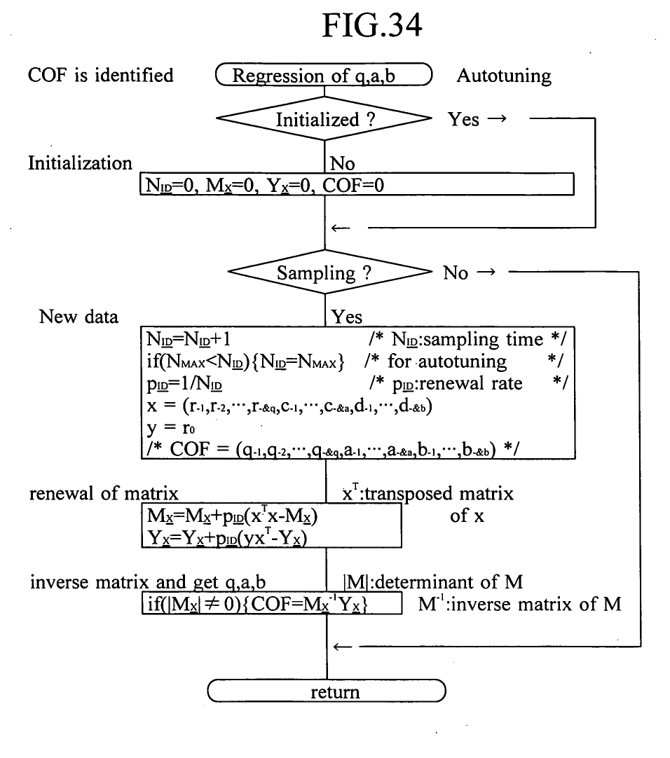

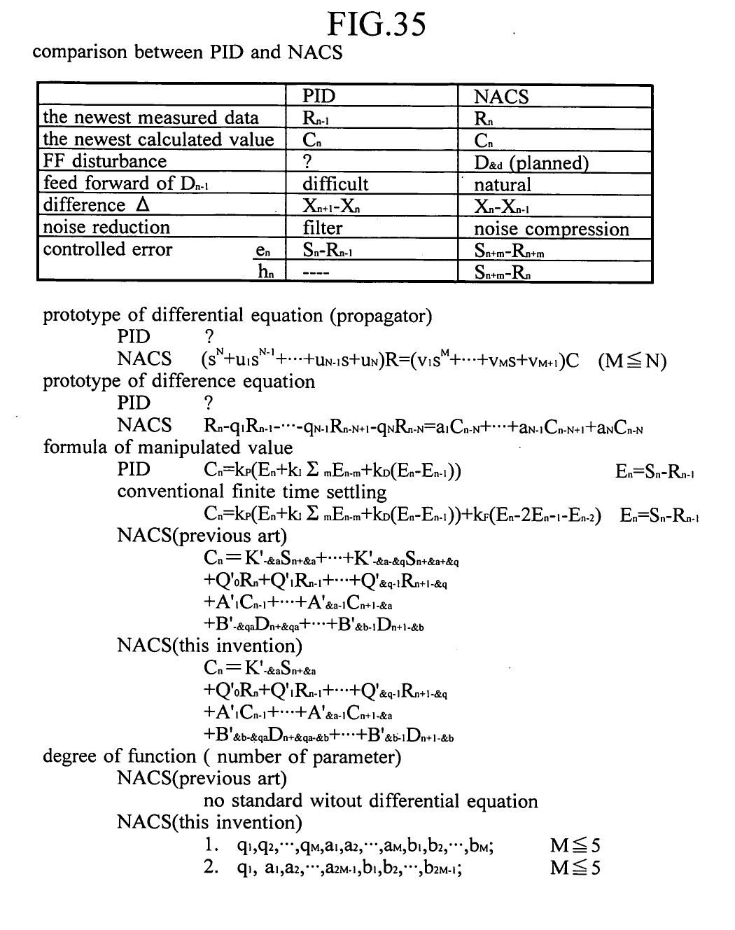

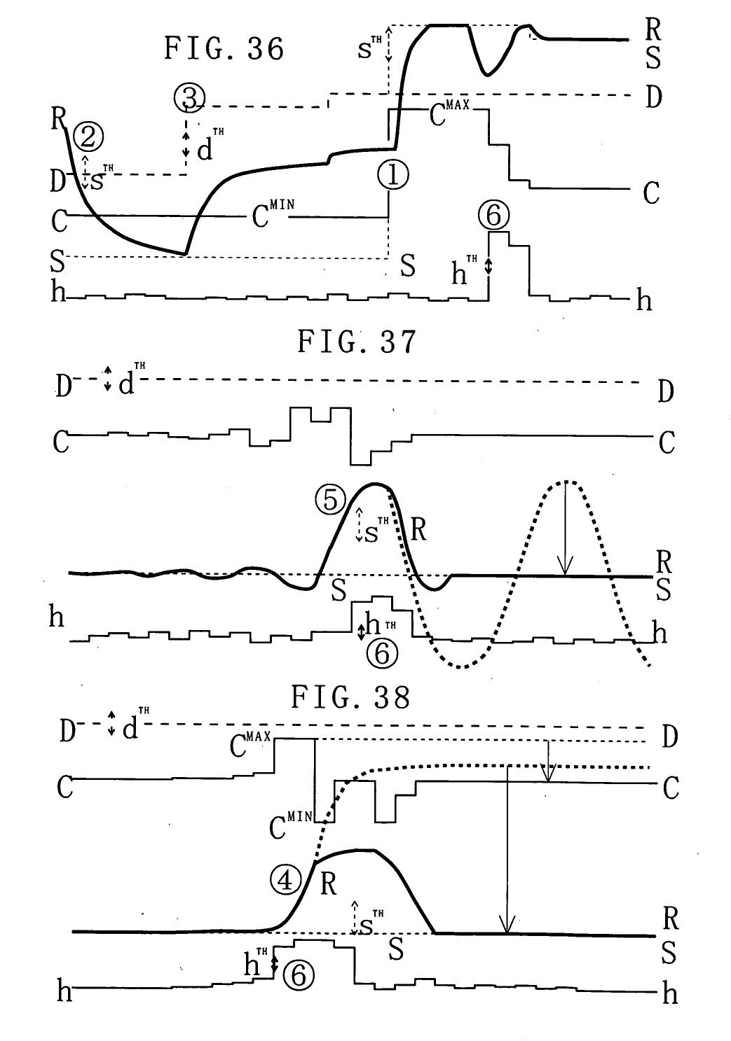

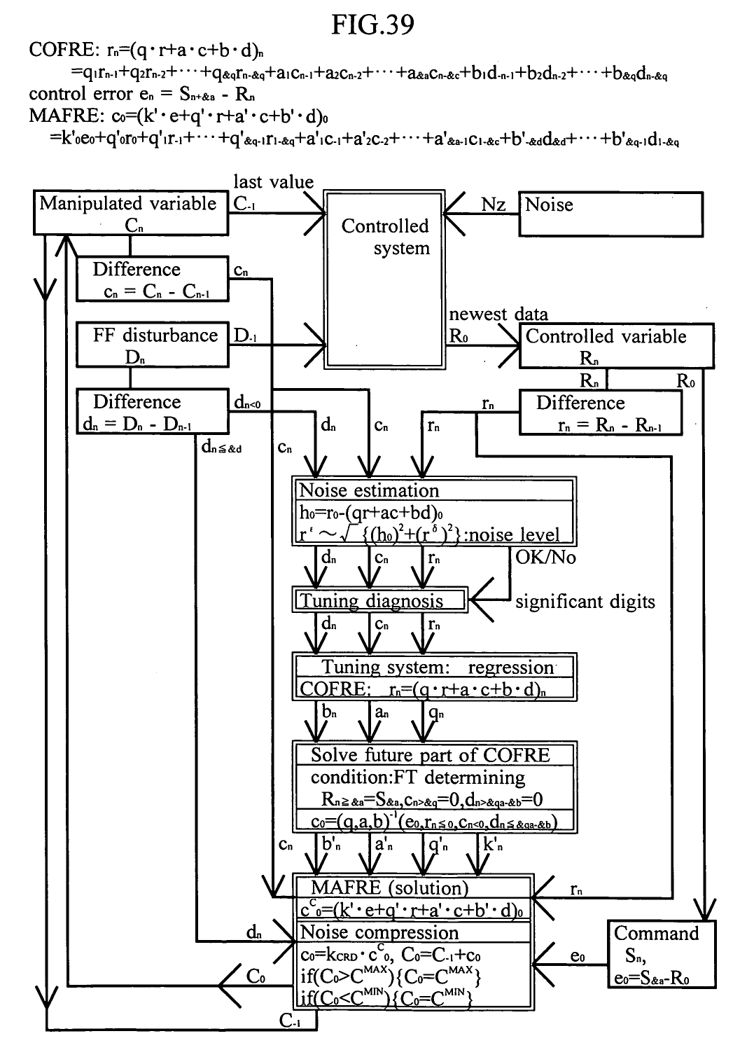

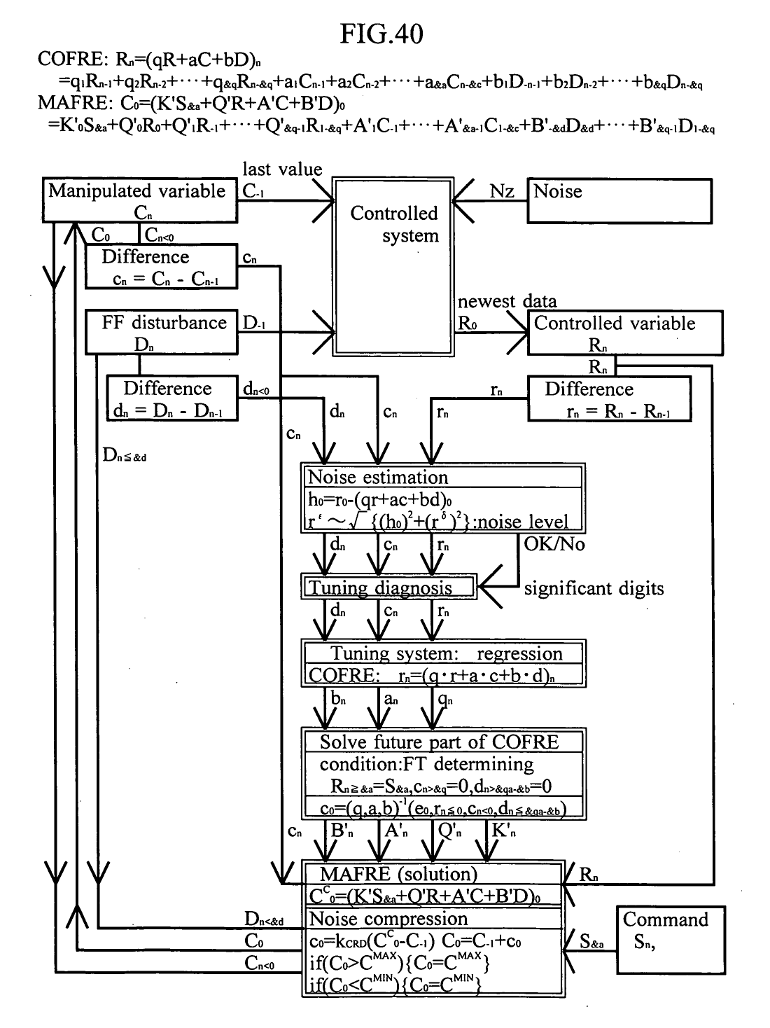

1. Digital control method that the newest controlled variable “R₀”, the command value “S_{&a}” (&a is settling time. It must be greater then or equal to the peak period #f of impulse response function fₙ. #f≦&a (FIG. 33)), and FF disturbance “D_{&d}” (disturbance, which is caused by program or which can be measured &d (≦&q+&a−&b) is the latest period to be fed forward. It depends the type of FF disturbance.) are given at the beginning of each control period, and the manipulated variable “C₀” (the 0th order of sequences represent present period 0.) is calculated solving future part of COFRE (transfer equation written in difference equation (FIGS. 1, 2)) under the condition of FF determining (R_{n≧&a}=S_{&a}, C_{n>&q}=C_{&q}, D_{n>&qa-&b}=D_{&q+&a-&b}; i.e. R becomes command value in &a periods, C becomes constant in &q periods, and planned values of “Dₙ” till &q+&a−&b periods after can be fed forward. &q, &a, and &b are sizes of COFRE coefficient (“qₙ”, “aₙ”, “bₙ”; q_{n<0}=q_{n>&q}=a_{n<0}=a_{n>&a}=b_{n<0}=b_{n>&b}=0. #f≦&a) C₀ is calculated using “Cₙ: −&a<n<0” and “Dₙ: −&b<n<&q+&a−&b”. FIG. 40.), and “C₀” is put out, so that control error caused by “Cₙ” and/or “Dₙ” can be corrected before that effect of “Cₙ” and/or “Dₙ” appears in “Rₙ”, and control precision is improved (FIGS. 7, 8), where coefficient (“qₙ”, “aₙ”, “bₙ”) is identified by the regression of COFRE using only data that have sufficient significant digits and when estimation error (|r₀−(qr−ac−bd)₀| i.e. difference between measured value r₀ and estimated value (qr−ac−b d)₀) is in the ordinary range (i.e. effect of not FF disturbance is small) so that even very large not FF disturbance happens in automatic tuning, the system restores stable as soon as FT disturbance is removed. (FIGS. 9, 39, 40)

2. Digital control method of claim 1 that is characterized by that manipulated variable is calculated using MAFRE (solution of future part of COFRE under the condition of FF determining) that is a linear formula of command value (S_{&a}), measured controlled values (R₀ and R_{n<0,n>-&q} or r_{n≦0,n>-&q}), out put manipulated values (C_{n<0,n>-&a} or c_{n<0,n>-&a}), and FT disturbance values (D_{n≦&d,n>-&b} or d_{n≦&d,n>-&b}) so that calculation becomes speedy when tuning is not carried out (FIG. 1, FIG. 2)

3. Digital control method of claim 1 that is characterized by that when the system restarts special routine (fast phase) runs and if estimation error exceeds the ordinary range then “aₙ” is tuned using only data in said fast phase (if necessary, response test is tried.) so that the system can adapt for the change during the interval of off-control. (FIG. 9)

4. Digital control method of claim 1 that is characterized by that size of parameters is selected as “1≦&q≦5, 1≦&a≦5, 0≦&b≦5” or “&q=1, 1≦&a≦9, 0≦&b≦9” so that trial and error time to determine the size of parameter becomes short.
